(19) United States
(12) Patent Application Publication
(10) Pub. No.: US 2026/0095104 A1
(43) Pub. Date: Apr. 2, 2026

(54) ZERO VOLTAGE SWITCHING FOR FLYBACK CONVERTER

(71) Applicant: TEXAS INSTRUMENTS INCORPORATED, Dallas, TX (US)

(72) Inventors: Saad Pervaiz, Murphy, TX (US); Michael Lueders, Freising (DE); Bing Lu, Bedford, NH (US)

(21) Appl. No.: 18/903,942

(22) Filed: Oct. 1, 2024

(51) Int. Cl. H02M 3/335; H02M 1/00

(52) U.S. Cl. CPC H02M 3/33592; H02M 1/0009; H02M 1/0058

(57) ABSTRACT

An apparatus includes a power converter that includes a coupled inductor including a primary side terminal and a secondary side terminal, a primary switch coupled to the primary side terminal, and a rectifier switch coupled to the secondary side terminal. The apparatus also includes a primary side controller coupled to the primary switch, and a secondary side controller coupled to the rectifier switch. The primary side controller is configured to transmit a control signal to the secondary side controller via a wireless channel, the control signal indicating an operation mode of a plurality of operation modes of the power converter.

### BACKGROUND

A power converter for transferring power from a power source to a load may convert between an alternating current (AC) voltage and a direct current (DC) voltage, or between different DC voltages. The power converter may also regulate the output voltage at a target voltage range to drive the load. One example of the power converter is a flyback converter, which may include a galvanic isolation between an input and one or more outputs, and may also include control circuits that control the operation of the flyback converter. A flyback converter can achieve a target voltage ratios, and may be used in both AC/DC and DC/DC conversion.

### SUMMARY

This summary is provided to introduce examples of disclosed concepts in a simplified form, which are further described below in the Detailed Description including the drawings provided.

According to certain aspects, an apparatus may include a power converter that includes a coupled inductor including a primary side terminal and a secondary side terminal, a primary switch coupled to the primary side terminal, and a rectifier switch coupled to the secondary side terminal. The apparatus may also include a primary side controller coupled to the primary switch, and a secondary side controller coupled to the rectifier switch. The primary side controller may be configured to transmit a control signal to the secondary side controller via a wireless channel, the control signal indicating an operation mode of a plurality of operation modes of the power converter.

According to certain aspects, an apparatus for controlling a power converter may include a controller configured to: generate a switch control signal for controlling a switch of the power converter, and generate a mode control signal that indicates a target operation mode selected from a plurality of operation modes of the power converter. The apparatus may also include a first output terminal configured to output the switch control signal to control the switch, and a second output terminal configured to transmit the mode control signal via a wireless channel.

According to certain aspects, an apparatus for controlling a power converter may include an input terminal configured to receive a mode control signal through a wireless channel, the mode control signal indicating a target operation mode selected from a plurality of operation modes of the power converter. The apparatus may also include a controller configured to, based on the mode control signal, determine the target operation mode, and generate a switch control signal for controlling a switch of the power converter in the target operation mode. The apparatus may further include an output terminal configured to output the switch control signal to control the switch.

According to certain aspects, a method may include: selecting, by a primary side controller of a power converter, an operation mode from a plurality of operation modes of the power converter; generating, by the primary side controller, a mode control signal based on the operation mode; transmitting, via a wireless channel, the mode control signal from the primary side controller to a secondary side controller of the power converter; generating, by the primary side controller and based on the operation mode, a primary switch control signal to control a primary switch on a primary side of the power converter; determining, by the secondary side controller, the operation mode based on the mode control signal; and generating, by the secondary side controller and based on the operation mode, a rectifier switch control signal to control a rectifier switch on a secondary side of the power converter.

The foregoing summary outlines rather broadly various features of examples of the present disclosure so that the following detailed description may be better understood. Additional features and advantages of such examples will be described hereinafter. This summary is neither intended to identify key or essential features of the claimed subject matters, nor is it intended to be used in isolation to determine the scope of the claimed subject matters. The subject matters should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative examples are described in detail below with reference to the following figures.

FIG. 1A is a schematic of an example of a power converter.

FIG. 1B is a schematic illustrating an example of an ON state of the power converter of FIG. 1A.

FIG. 1C is a schematic illustrating an example of an off state of the power converter of FIG. 1A.

FIG. 2 is a block diagram of an example of a control circuit of a power converter.

FIG. 3 is a flowchart illustrating an example of controlling the operation of a power converter using a primary side controller and a secondary side controller.

FIG. 4 is a flowchart illustrating an example of controlling a power converter operating in a continuous conduction mode (CCM).

FIG. 5 is a graph illustrating examples of voltage signals and current signals of a power converter operating in the continuous conduction mode.

FIG. 6 is a flowchart illustrating an example of controlling a power converter operating in a quasi-resonant mode.

FIG. 7 is a graph illustrating examples of voltage signals and current signals of a power converter operating in the quasi-resonant mode.

FIG. 8 is a flowchart illustrating an example of controlling a power converter operating in a discontinuous conduction mode (DCM).

FIG. 9 is a graph illustrating examples of voltage signals and current signals of a power converter operating in the discontinuous conduction mode.

FIG. 10 is a flowchart illustrating an example of a process of adjustive negative secondary side current to achieve zero voltage switching (ZVS) of the primary switch.

FIG. 11 is a graph illustrating examples of voltage signals and current signals of a power converter while performing the process of FIG. 10.

The drawings and accompanying detailed description are provided for understanding of features of various examples and do not limit the scope of the appended claims. The examples illustrated in the drawings and described in the accompanying detailed description may be readily utilized as a basis for modifying or designing other examples that are within the scope of the appended claims. One skilled in the art will readily recognize from the following description that alternative embodiments of the structures and methods illustrated may be employed without departing from the principles, or benefits touted, of this disclosure. Identical reference numerals may be used, where possible, to designate identical elements that are common among drawings. The figures are drawn to clearly illustrate the relevant elements or features and are not necessarily drawn to scale.

### DETAILED DESCRIPTION

The present disclosure relates generally to power converters. According to some examples, a flyback converter can operate in a plurality of modes, such as a continuous conduction mode (CCM), a quasi-resonant (QR) mode, discontinuous conduction modes (DCMs) having different switching time (e.g., skipping different numbers of voltage valleys at a primary side terminal), and the like. The operation mode can be selected by a primary side controller of the flyback converter. A communication signal indicating the selected operation mode may be transmitted by the primary side controller to a secondary side controller via an isolation channel, such that the secondary side controller may control the secondary side switching according to the operation mode. For example, the different operation modes may be communicated to the secondary side controller using a control signal that includes one or more pulses, where different numbers of pulses may indicate different operation modes. In addition, in some examples, in the quasi-resonant mode and discontinuous conduction modes, when the primary switch is turned off, the secondary side current may be controlled so that it may become negative after reaching zero. The negative current on the secondary side may cause a negative current on the primary side. The negative current on the primary side may discharge a primary side terminal (e.g., coupled to a drain of the primary switch) of the flyback converter, such that the voltage level at the primary side terminal may reach zero before the primary switch is turned on for the new switch cycle, thereby achieving zero voltage switching to reduce switching loss and improve efficiency, without using an active clamp circuit that may include a high-voltage field effect transistor (FET) and thus may be more expensive and introduce additional loss. The negative current on the secondary side may be achieved by, for example, delaying the switching off of the rectifier switch from the detection of a zero crossing of the secondary side current or a valley of a voltage at a secondary side terminal. The delay time may be selected such that the voltage at the primary side terminal (or a terminal such as the drain of the primary switch) may reach zero before the primary switch is switched on.

A flyback converter may include a coupled inductor (e.g., a transformer) and two switches (e.g., FETs and/or diodes) on the primary side and the secondary side, respectively, of the coupled inductor. The flyback converter may also include control circuits for controlling the switching of the two switches. Power from an input may be stored in the coupled inductor by magnetizing the inductor when the switch on the primary side (referred to hereinafter as primary switch) is turned on. The stored power may be transferred to the secondary side to charge an output capacitor and drive a load when the primary switch is turned off and the switch on the secondary side (referred to hereinafter as secondary switch or rectifier switch). The coupled inductor may also provide isolation between the input and an output of the flyback converter. By selecting the turns ratio between the primary side winding and the secondary side winding of the coupled inductor and/or the time period of a switch cycle during which the primary switch is turned on, the output voltage may be set to be higher or lower than the input to support a wide input voltage range and a wide output voltage range. A flyback converter may also be able to support multiple outputs by using more windings (or inductors) in the coupled inductor. In some examples, the primary switch may be a FET, such as a high electron mobility transistor (HEMT), whereas the secondary switch or rectifier switch may be a diode or a FET. When a FET is used as the rectifier switch and is synchronized with the primary switch, the rectifier switch may be a synchronous rectifier (SR).

A flyback converter may generally have two operation phases, the on state and off state. In the on state, the primary switch (e.g., a FET) may be switched on, and thus current may flow from the input through the primary inductor and the primary switch to magnetize the coupled inductor and create a magnetic field around it. In the secondary side, the rectifier switch may be reverse-biased or otherwise switched off, thereby disconnecting the coupled inductor from the output. Charges stored in an output capacitor may be used to maintain a stable voltage V_{OUT} at the load in the on state. During the off state, the primary switch may be switched off, and the coupled inductor may begin to demagnetize through the rectifier switch, which may now be forward biased or otherwise switched on. The current from the coupled inductor through the rectifier switch may charge the output capacitor and drive the load during the off state. The duration of the on state in a switch cycle (e.g., the duty cycle of a switch cycle) may be selected based on desired relationship between the input voltage level and the voltage across the primary side winding (referred to herein as flyback voltage V_{FLY}) of the flyback converter. For example, the duty cycle may be determined to be V_{FLY}/(V_{IN}+V_{FLY}).

Flyback converters may be used in switch-mode power supplies for AC/DC and DC/DC conversion, due to, for example, its simple structure, high efficiency, and robustness across a wide voltage range. Flyback converters may also offer the advantages of galvanic isolation, low cost, and small size, which makes it attractive for low-power and medium-power (e.g., between about 2 W to 100 W) applications, such as power adapters and mobile equipment chargers. But there may be some challenges associated with flyback converters.

For example, when the flyback converter transitions from the on state to the off state, the primary switch is turned off, the current flowing through the magnetizing inductance of the coupled inductor to the primary switch is interrupted and may start to decrease, and the energy stored in the magnetizing inductance may be transferred to the secondary side through the transformer. Due to the decreasing of the magnetizing current (Iₘ), the voltage drop on the primary side winding may be reversed. Therefore, the voltage across the two terminals (e.g., drain and source) of the primary switch may have a spike with a peak level equal to the sum of the input voltage V_{IN} and the voltage drop on the primary side winding (e.g., about N×V_{OUT} when the turns ratio between the primary side winding and the secondary side winding is about N:1). Thus, the voltage spike may be high and may damage the primary switch. In some examples, a voltage clamp circuit may be used to dissipate the stored energy from the primary side winding to protect the primary switch. In one example, the voltage clamp circuit may be a passive clamp circuit that may include a Zener diode and a blocking diode connected in series. The passive clamp circuit may be relatively simple and inexpensive, but may reduce the system efficiency because it may dissipate the energy stored in the primary side winding as heat, and the power loss may increase with the switching frequency. In addition, existing passive clamp circuits may not be able to achieve zero voltage switching when V_{IN}>N×V_{OUT}.

According to certain examples, the switch timing of the secondary switch can be controlled to achieve zero voltage switching (ZVS) of the primary switch. Specifically, the secondary side current may be controlled by controlling the switch timing of the secondary switch so that the secondary side current may ramp from a positive current at the beginning of the off state down to a zero current and then further ramp down to become negative. When the rectifier switch is turned off, the negative secondary side current may cause a negative current in the primary side winding through the coupled inductor. The negative current on the primary side caused by the negative secondary side current may discharge the primary side terminal that is coupled to a first terminal (e.g., the drain) of the primary switch to reduce the voltage at the primary side terminal to zero, thereby achieving zero voltage switching to reduce switching loss and improve efficiency. Due to the limited voltage swing across the secondary switch, the secondary switch needs not be a high voltage FET. The negative current in the secondary side winding may be achieved by, for example, keeping the rectifier switch turned on for a certain time period from the detection of a valley of a voltage at a secondary side terminal that is coupled to the rectifier switch (or a zero crossing of the secondary side current) to allow the secondary side current to further reduce to become a negative current. The delay time may be selected such that the voltage of the primary side terminal (or the drain of the primary switch) may reach zero before the primary switch is switched on in the next switch cycle, to achieve ZVS of the primary switch.

The switch timing of the secondary side can also be controlled to support several modes of operation of the flyback converter. For example, a flyback converter may operate in a discontinuous conduction mode (DCM), which may allow the coupled inductor to completely demagnetize during each switch cycle. In the DCM mode, after the demagnetizing period, there may be a time period before the primary switch is turned on again to start the next switch cycle. This time period may be referred to as a dead-time or resonant time. During this time period of a switch cycle, neither the primary switch nor the rectifier switch is conducting, and the coupled inductor may be completely demagnetized. A resonant ring may be generated during this time period due to, for example, the interaction between the inductance of the coupled inductor and the parasitic capacitance of the rectifier switch. An amplitude (e.g., voltage or current) of the resonant ring may vary (e.g., oscillate) as a function of time. The resonant ring may include peaks and valleys. For example, a valley of the voltage at the primary side terminal or the first terminal (e.g., a drain) of the primary switch (e.g., a FET) may have a voltage level about V_{IN}−N×V_{OUT}. A converter in deep discontinuous mode can have a dead-time long enough for the resonant ring to dampen completely, such that the drain to source voltage of the primary switch may settle to about the input voltage V_{IN}. In order to minimize switching losses, a controller may detect a low point (e.g., a valley) of the resonant ring, before turning on the primary switch again to start the next switch cycle. In different DCM modes, the primary switch may be turned on at different valleys of the resonant ring, such as the first valley, the second valley, the third valley, and so on. For example, Quasi-resonant (QR) mode is one example of a DCM mode where the switching may occur at the first resonant valley of the voltage at the primary side terminal. Flyback converters operating in DCM modes may have low or no reverse recovery losses in the rectifier switch because the secondary side current is able to ramp down to zero amps in each switch cycle. A flyback converter in a DCM mode may be more stable because it does not have a right-half-plane zero in its transfer function. But flyback converters in DCM modes may have relatively large ripple currents, and may have relatively high losses if the switches are turned on or off when the drain to source voltage of the switches is non-zero.

A flyback converter may also operate in a continuous Conduction Mode (CCM). In the CCM operation, a continuous current is flowing in the coupled inductor during each switch cycle. When the primary switch is turned on, the primary current ramps up from a non-zero offset because residual energy is continuously maintained in the transformer. When the primary switch is turned off and the rectifier switch is turned on, energy may be transferred to the secondary side and the coupling inductor may gradually demagnetize, resulting in a secondary side current that gradually ramps down. But the secondary side current may not ramp down to zero int the CCM mode, and thus residual energy may be maintained in the transformer when the next switch cycle begins. Flyback converters operate in the CCM mode may have small ripple current and root mean square (RMS) current, which may result in lower capacitor losses and lower conduction and turn-off losses compared with DCM flyback converters. Flyback converters in CCM mode may have a right-half-plane zero in the power stage transfer function, which may limit the bandwidth of the control loop and impact the dynamic response.

Therefore, a flyback converter may realize high efficiency and low ripple when it works in the continuous conduction mode (CCM) for a low input voltage. The discontinuous conduction mode (DCM) may be more suitable for operating at high input voltage. Thus, to improve the efficiency and reduce ripples and size of the power converter, the power converter may operate in the CCM mode for a low input voltage and operate in the DCM mode for a high input voltage. In some examples, a primary side controller may be able to dynamically select the operation mode of the power converter. But the information of the operation mode would need to be communicated to the secondary side controller so that the secondary side controller can control the secondary switch according to the selected operation mode.

According to certain examples, information regarding the operation mode selected by the primary side controller may be communicated to the secondary side controller via one isolation channel that does not conduct a current between the primary side and the secondary side of the power converter. The primary side controller may send a mode control signal indicating the selected operation mode to the secondary side controller through the isolation channel. The mode control signal may include, for example, one or more pulses, where different numbers of pulses may indicate different operation modes. For example, one pulse in a switch cycle of the mode control signal may indicate that the selected operation mode is the CCM mode, two pulses in a switch cycle of the mode control signal may indicate that the selected operation mode is the QR mode, three pulses in a switch cycle of the mode control signal may indicate that the selected operation mode is the DCM mode where the primary switch may be turned on at the second valley of the resonant ring of the voltage of the primary side terminal, four pulses in a switch cycle of the mode control signal may indicate that the selected operation mode is the DCM mode where the primary switch may be turned on at the third valley of the resonant ring of the voltage of the primary side terminal, and so on.

In one example, the primary side controller may select the CCM mode and transmit a control signal through an isolation channel to indicate the CCM operation mode. The control signal may include, for example one pulse in each switch cycle. The primary side controller may turn on the primary switch after a predetermined delay has elapsed from the transmission of the control signal, so that the rectifier switch may be turned off before the primary switch is turned on. The primary side controller may turn off the primary switch after the primary switch is in the on state for a time period, where the time period (or the duty cycle) may be selected based on the desired relationship between the input voltage level and the voltage across the primary side winding of the coupled inductor. The secondary side controller may receive the control signal, determine that the power converter operates in the continuous conduction mode based on the control signal, turn off the rectifier switch after a predetermine duration from receiving the control signal, and turn on the rectifier switch in response to a voltage across the rectifier switch (or a voltage at a secondary side terminal) reaching zero.

In another example, the primary side controller may select the QR mode and transmit the control signal through an isolation channel to indicate the QR mode. The primary side controller may turn on the primary switch in response to a voltage at the primary side terminal reaching zero, and turn off the primary switch after the primary switch is in the on state for a time period. The time period (or the duty cycle) may be determined based on the desired relationship between the input voltage level and the voltage across the primary side winding of the coupled inductor. The secondary side controller may receive the control signal, determine that the power converter operates in the quasi-resonant mode based on the control signal, turn on the rectifier switch in response to a voltage across the rectifier switch (or at a secondary side terminal) reaching zero, and, responsive to a zero crossing of a current at the secondary side terminal, turn off the rectifier switch after a predetermined delay has elapsed from the zero crossing.

In yet another example, the primary side controller may select a DCM mode and transmit a control signal through an isolation channel to indicate a discontinuous conduction mode and timing for turning on the primary switch in the switch cycle. The primary side controller may turn on the primary switch responsive to a voltage at the primary side terminal reaching zero, and turn off the primary switch after the primary switch is in the on state for a time period. The time period (or the duty cycle) may be determined based on the desired relationship between the input voltage level and the voltage across the primary side winding of the coupled inductor. The secondary side controller may receive the control signal through the isolation channel, determine that the power converter operates in the discontinuous conduction mode based on the control signal, determine a condition for turning on the rectifier switch for a second time in the switch cycle based on the control signal, turn on the rectifier switch for a first time in response to a voltage across the rectifier switch (or a voltage at a secondary side terminal) reaching zero for a first time in the switch cycle, turn off the rectifier switch in response to a zero crossing of a current at the secondary side terminal, turn on the rectifier switch for the second time in the switch cycle in response to detecting the condition, and turn off the rectifier switch after a predetermined delay has elapsed from turning on the rectifier switch for the second time. The condition may include, for example, a number of valleys of a voltage of the secondary side terminal have been detected, a number of peaks of the voltage of the secondary side terminal have been skipped, a number of zero crossings of a current of the secondary side terminal have been detected, a predetermined delay has elapsed, or a combination thereof.

Various features are described hereinafter with reference to the figures. An illustrated example may not have all the aspects or advantages shown. An aspect or an advantage described in conjunction with a particular example is not necessarily limited to that example and can be practiced in any other examples even if not so illustrated or if not so explicitly described. Further, methods described herein may be described in a particular order of operations, but other methods according to other examples may be implemented in various other orders (e.g., including different serial or parallel performance of various operations) with more or fewer operations.

Various examples are described herein. Although the specific examples may illustrate various aspects of the above generally described features, examples may incorporate any combination of the above generally described features (which are described in more detail in examples below). Three dimensional x-y-z axes are illustrated in some figures for ease of reference. Some cross-sectional views of various semiconductor devices herein may be general depictions to illustrate various aspects or concepts concerning such semiconductor devices. More specifically, some drain contact structures illustrated in cross-sectional views may not necessarily accurately depict a structure of such drain contact contacts, except to the extent described herein. The illustrations of those drain contact structures are to illustrate various aspects or concepts concerning those drain contact structures.

In the following description, for the purposes of explanation, specific details are set forth in order to provide a thorough understanding of examples of the disclosure. However, it will be apparent that various examples may be practiced without these specific details. For example, devices, systems, structures, assemblies, integrated circuits, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

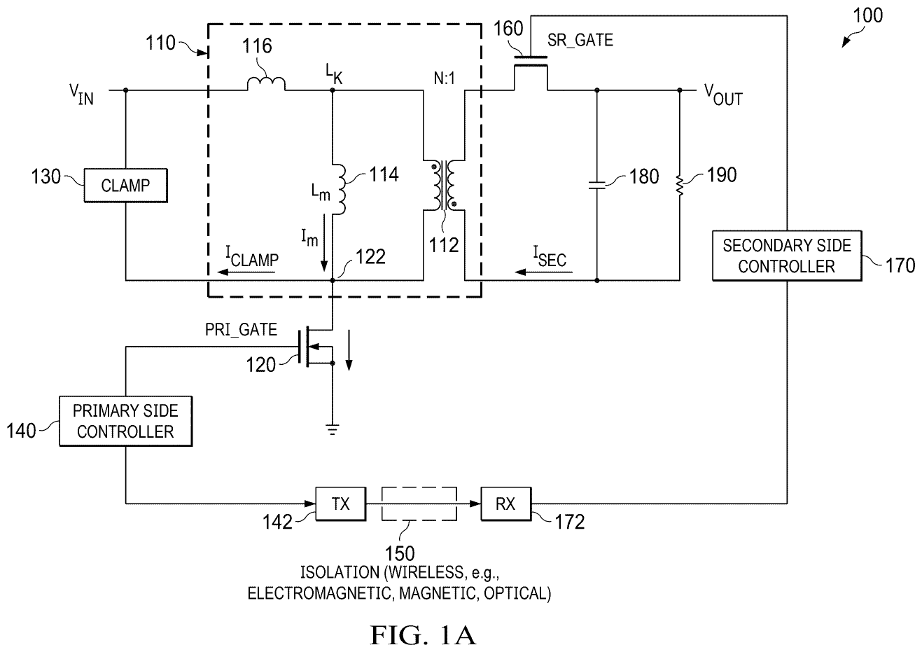

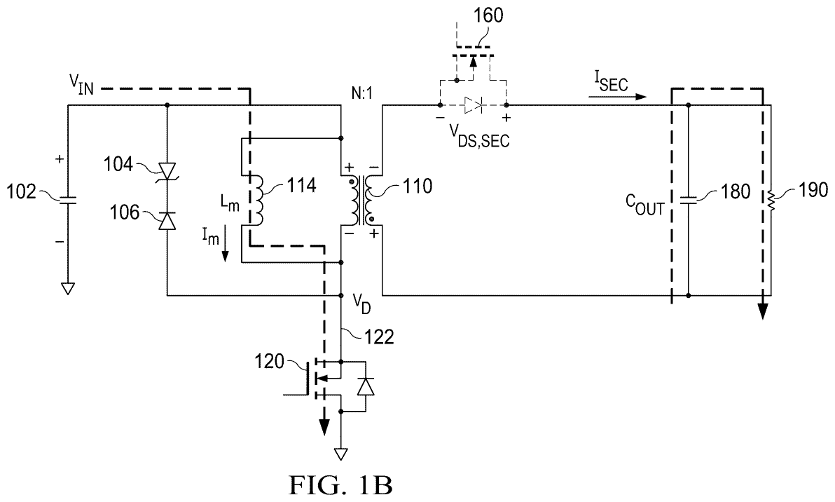

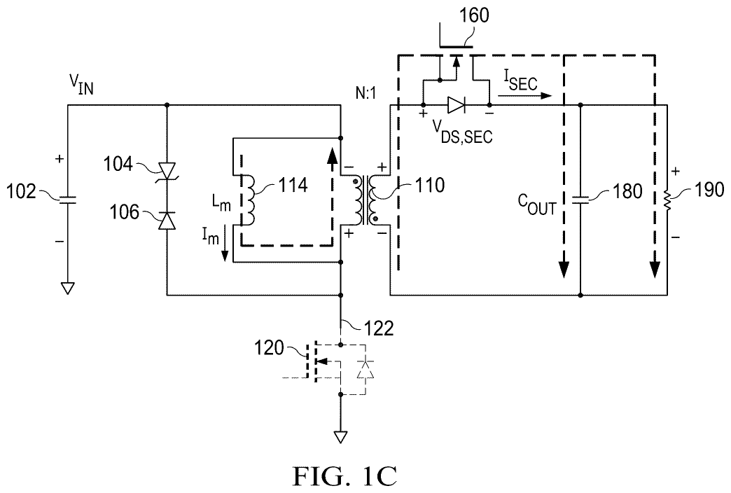

FIG. 1A is a schematic of an example of a power converter 100. Power converter 100 may be a flyback converter, and may include a coupled inductor 110, a primary switch 120, a primary side controller 140, a rectifier switch 160, and a secondary side controller 170. Coupled inductor 110 may include a transformer 112, a magnetizing inductor 114 (Lₘ), and a leakage inductor 116 (L_{K}). The transformer 112 may have a turn ratio N:1, such that the voltage ratio between the primary side and the secondary side of transformer 112 may be N:1. As illustrated, the secondary side winding of coupled inductor 110 may have a polarity that is opposite to the polarity of the primary side winding.

Primary switch 120 may include a transistor, such as a field effect transistor or a bipolar transistor. In one example, primary switch 120 may include a high electron mobility transistor (HEMT), such as a gallium nitride (GaN) HEMT. In another example, primary switch 120 may include a silicon MOSFET or another FET. Compared to a silicon-based device, a GaN-based device may have lower on-resistance, higher breakdown voltage, better reverse-recovery characteristics, and higher operating temperatures. A GaN-based device may also have much lower switching losses, and can operate at higher switching frequencies. Higher switching frequencies may allow for the use of smaller capacitors, inductors, and transformers, which may result in reduction in power, size, weight, and cost. Primary switch 120 may be connected between a primary side terminal of coupled inductor 110 and ground, and may be controlled by primary side controller 140. For example, primary switch 120 may be a FET where the drain of the FET may be coupled to a primary side terminal of coupled inductor 110, the source of the FET may be coupled to ground, and the gate of the FET may be coupled to an output of primary side controller 140.

Primary side controller 140 may be used to generate a control signal for controlling the switching of primary switch 120. In some examples, primary side controller 140 may determine an operation mode of power converter 100. Primary side controller 140 may be coupled to a transmitter 142 or may include transmitter 142, such that the information of the operation mode of power converter 100 may be transmitted to secondary side controller 170 through transmitter 142, an isolation channel 150, and a receiver 172. Receiver 172 may be coupled to secondary side controller 170 or may be part of secondary side controller 170.

Isolation channel 150 may be used to transmit a signal from primary side controller 140 to secondary side controller 170, such that primary side controller 140 may be synchronized with secondary side controller 170, and thus the switching of primary switch 120 and rectifier switch 160 may be synchronized for synchronized rectification (e.g., in CCM mode). Isolation channel 150 may transmit the signal from the primary side to the secondary side of power converter 100, without a direct current path between the primary side and the secondary side of power converter 100. For example, isolation channel 150 may include a magnetic communication channel (e.g., including a transformer or coupled inductor), an optical communication channel (e.g., using infrared light), an electromagnetic communications channel (e.g., using a pair of radio frequency or microwave transmitter and receiver). As described in more detail below, in some examples disclosed herein, isolation channel 150 may also be used to communicate the operation mode information from the primary side to the secondary side of power converter 100, so that power converter 100 can dynamically change its operation mode to operate in different modes at different time.

In some examples, the primary side of power converter 100 may also include a clamp circuit 130, which may include a Zener diode and a blocking diode connected in series. As described above, when primary switch 120 is turned off, the magnetizing current (Iₘ) flowing through the magnetizing inductor 114 (Lₘ) may start to decrease, which may cause the voltage drop on magnetizing inductor 114 to be reversed. Therefore, the voltage across the two terminals (e.g., the drain and source) of primary switch 120 may have a spike with a peak level equal to the sum of the input voltage and the voltage drop on the primary side inductors (e.g., magnetizing inductor 114 and leakage inductor 116). For example, the peak level of the voltage spike may be approximately the sum of the input voltage and N times of the output voltage (where N:1 is the turns ratio of the coupled inductor), which may be high and may otherwise damage the primary switch. Clamp circuit 130 may be used to clamp the voltage level at a terminal 122 (e.g., the drain) of primary switch 120 (which may be connected to a primary side terminal of coupled inductor 110), so that the voltage across the two terminals of primary switch 120 may be within a certain voltage level to avoid damage to primary switch 120.

Rectifier switch 160 may also include a transistor, such as a FET or a bipolar transistor. Rectifier switch 160 may be controlled by secondary side controller 170. Secondary side controller 170 may receive the signal from primary side controller 140 through isolation channel 150, determine the operation mode based on the received signal, and control rectifier switch 160 accordingly. Power converter 100 may also include an output capacitor 180 (or another charge storage device), which may store charges when rectifier switch 160 is turned on and may discharge to drive a load 190 when rectifier switch 160 is turned off.

FIG. 1B is a schematic illustrating an example of an on state of power converter 100 of FIG. 1A. As described above, a flyback converter may have two operation states including an on state and an off state. As shown in FIG. 1B, in the on state, primary switch 120 may be turned on to conduct current, such that current from the input (V_{IN}) may flow through magnetizing inductor 114 (and leakage inductor 116) and primary switch 120. The current from the input may magnetize magnetizing inductor 114 to store energy in magnetizing inductor 114. In the on state, rectifier switch 160 may be turned off, and thus the current from the input may not flow through the primary side of the ideal transformer to cause a current in the secondary side of the ideal transformer. Charges stored in output capacitor 180 may be used to drive load 190. FIG. 1B also shows an input capacitor 102 and a passive clamp circuit that may include a Zener diode 104 and a blocking diode 106 connected in series.

FIG. 1C is a schematic illustrating an example of an off state of power converter 100 of FIG. 1A. In the off state, primary switch 120 may be turned off, while rectifier switch 160 may be turned on. When primary switch 120 is turned off, current flowing from the input through magnetizing inductor 114 may not be able flow through primary switch 120, and thus may start to decrease but may not decrease to zero instantaneously due to the inductance on the primary side. The decrease of the magnetizing current (Iₘ) may cause the voltage drop on the primary side inductor (e.g., including magnetizing inductor 114 and leakage inductor 116) to change polarity as shown in FIG. 1C. Thus, the magnetizing current may flow through the primary side winding of transformer 112 in a path as shown in FIG. 1C. The current flowing through the primary side winding of transformer 112 may cause a current in the secondary side winding of transformer 112. Due to the opposite polarity of the primary side winding and the secondary side winding, the voltage level at a terminal of the secondary side winding coupled to rectifier switch 160 may be higher than the opposite terminal of the secondary side winding, and thus the current in the secondary side winding of transformer 112 may flow through rectifier switch 160 to charge output capacitor 180 and drive load 190. In addition, as shown in FIG. 1C, the voltage across primary switch 120 (or drain voltage V_{D} at the drain terminal when the source terminal of primary switch 120 is coupled to ground) may be equal to the sum of the input voltage (V_{IN}) and the voltage drop on the primary side inductor due to the polarities of the voltages. Thus, a clamp circuit (such as Zener diode 104 and blocking diode 106 connected in series and oppositely biased) may be used to clamp the voltage at terminal 122 of primary switch 120.

In some operation modes, such as DCM modes or the QR mode, there may be a time period (e.g., a dead-time) in the off state during which both primary switch 120 and rectifier switch 160 are turned off, and both switches would not conduct current (thus the power converter has discontinuous conduction). During this time period of a switch cycle, the power converter may resonate due to the interaction between the inductance of coupled inductor and the parasitic capacitance of the rectifier switch. Thus, resonant ringing may occur in the current and voltage level of the primary side and the secondary side of the coupled inductor during this time period. For example, the minimum voltage level (a valley of the resonant ring) at terminal 122 may be equal to V_{IN}−NV_{OUT}, where V_{IN} is the input voltage, V_{OUT} is the output voltage, and N:1 is the turns ratio between the primary side winding and the secondary side winding of coupled inductor 110. Thus, when the input voltage V_{IN} is higher than NV_{OUT}, the voltage level at terminal 122 may not reach zero. The resonant ringing may be gradually dampened such that the amplitude of the resonant ring may gradually reduce.

As described in more details below, in some examples disclosed herein, the secondary side current of power converter 100 may be controlled by secondary side controller 170 so that a negative current may be generated on the primary side during the dead-time period to fully discharge terminal 122, thereby achieving zero voltage switching of primary switch 120. Moreover, because the voltage swing across rectifier switch 160 is limited, rectifier switch 160 needs not be a high voltage transistor, which can reduce the overall size of the power converter.

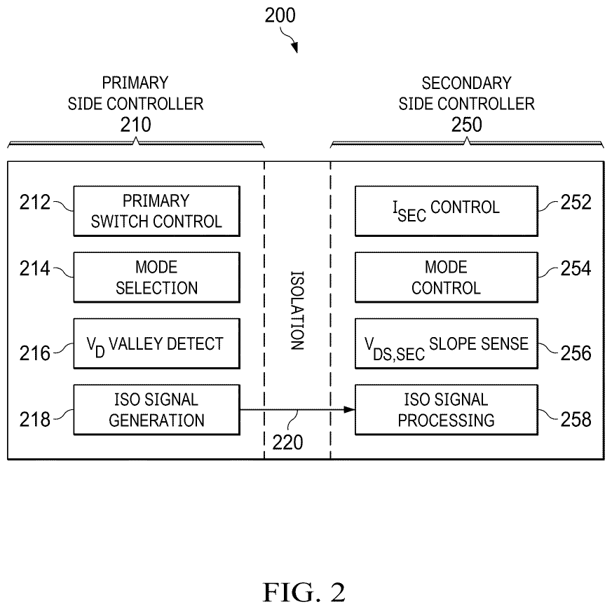

FIG. 2 is a block diagram of an example of a control circuit 200 of a power converter, such as power converter 100. Control circuit 200 may include a primary side controller 210 and a secondary side controller 250 communicatively coupled through an isolation channel 220. In some examples, various components of control circuit 200 can be implemented in any suitable circuit or component capable of performing processing and/or control, such as a processer, microprocessor, controller, microcontroller, field-programmable gate array (FPGA), or any other combination of analog and/or digital components arranged in an architecture that provides processing and control capabilities.

Primary side controller 210 may be an example of primary side controller 140 of FIG. 1 and may include, for example, a primary switch control circuit 212, an operation mode selection block 214, a circuit 216 for detecting a zero voltage level (or a valley) at a primary side terminal of the coupled inductor or a terminal of the primary switch (e.g., a drain of a switch transistor, such as terminal 122 of primary switch 120), and an isolation channel signal generation circuit 218. Secondary side controller 250 may be an example of secondary side controller 170 of FIG. 1 and may include, for example, a secondary side current control circuit 252, a mode control block 254, a circuit 256 for sensing or detecting the voltage and/or voltage slope across the rectifier switch (e.g., rectifier switch 160), and an isolation channel signal processing circuit 258.

Isolation channel 220 may be similar to isolation channel 150 described above, and may provide a communication path from primary side controller 210 to secondary side controller 250. For example, isolation channel 220 may include a magnetic communication channel (e.g., including a transformer or coupled inductor), an optical communication channel (e.g., using infrared light), an electromagnetic communications channel (e.g., using a pair of radio frequency or microwave transmitter and receiver). Isolation channel 220 may be used to synchronize primary side controller 210 and secondary side controller 250 in CCM mode, and may also be used to dynamically communicate the selected operation mode information from primary side controller 210 to secondary side controller 250, as described in more detail below.

Primary switch control circuit 212 may, based on the operation mode selected by operation mode selection block 214 and/or a zero voltage level (or a valley) at a terminal of the primary switch (e.g., a drain of a switch transistor, such as terminal 122 of primary switch 120) detected by circuit 216, control the switching timing of primary switch 120, including the timing for switching on and switching off the primary switch in each switch cycle. As described above, the power converter may be able to operate in a CCM mode, a QR mode, and DCM modes, where the QR mode may be one example of DCM mode. A flyback converter can realize high efficiency and low ripple when it works in the CCM mode, whereas a flyback converter in a DCM mode may be more suitable for operating at high input voltage. Primary side controller 210 may determine the appropriate operation mode or may receive the operation mode from another controller, such as a center controller of a system. Primary side controller 210 may generate a mode control signal indicating the operation mode of the power converter for transmission to secondary side controller 250 through isolation channel 220.

In the CCM mode, primary switch control circuit 212 may send the mode control signal to secondary side controller 250 and then turn on the primary switch after a certain delay from sending the mode control signal, so that secondary side controller 250 may receive the mode control signal and turn off the rectifier switch after a delay before the primary switch is turned on. Thus, the mode control signal may be used as a synchronization signal to synchronize the switching of the primary switch and the rectifier switch in the CCM mode.

In the DCM modes (including the QR mode), circuit 216 may detect whether the terminal of the primary switch (e.g., a drain of a switch transistor, such as terminal 122 of primary switch 120) coupled to the coupled inductor reaches a zero voltage level or a valley of the resonant ring. As described above, the valley of the resonant ring may not be zero when the input voltage V_{IN} is greater than NV_{OUT}. When a zero voltage level or one or more valleys of the resonant ring are detected, primary side controller 210 may turn on the primary switch. When the valley does not reach zero, zero voltage switching generally may not be achieved using the valley switching technique and a passive clamp circuit. However, using techniques disclosed herein, zero voltage switching may be achieved in DCM mode even if the valley of the resonant ring at the terminal of the primary switch does not reach zero.

Secondary side controller 250 may receive the mode control signal from primary side controller 210 through isolation channel 220, and process the mode control signal using isolation channel signal processing circuit 258. According to the operation mode, mode control block 254 of secondary side controller 250 may control the switching of the rectifier switch based on, for example, the detection results of voltage and/or voltage slope across the rectifier switch by circuit 256. For example, in the CCM mode, mode control block 254 may turn off the rectifier switch after a delay period from receiving the mode control signal, and may turn on the rectifier switch when circuit 256 detects that a voltage across the rectifier switch (or a voltage level at the terminal of the rectifier switch that is coupled to a secondary side terminal of the coupled inductor) reaches zero. In the DCM modes, mode control block 254 may turn on rectifier switch one or more times in each switch cycle and turn off the rectifier switch one or more times in each switch cycle, based on the voltage level and/or current at a secondary side terminal of the coupled inductor detected or measured by circuit 256, as the voltage level and/or current at the secondary side terminal may indicate whether the primary switch is turned on or off, or whether the voltage at the primary side terminal reaches a valley or a zero voltage level.

Secondary side current control circuit 252 may be used to determine the time period that the rectifier switch may remain turned on after a zero crossing of the current at the secondary side terminal, where, during the time period, the current flowing through the secondary side winding of the coupled inductor may become negative such that, after the rectifier switch is turned off, a current flowing through the primary side winding may also become negative, thereby discharging the terminal of the primary switch to achieve zero voltage switching. In some examples, secondary side current control circuit 252 may determine if the terminal of the primary switch reaches zero volts based on a slope of the voltage level at the terminal of the rectifier switch determined by circuit 256.

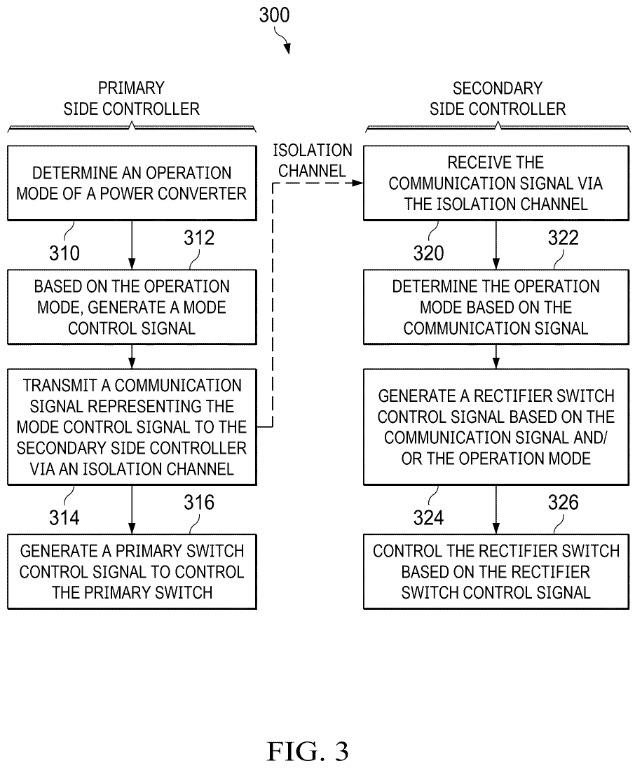

FIG. 3 is a flowchart of a method 300 illustrating an example of controlling the operation of a power converter using a primary side controller and a secondary side controller. In the illustrated example, the primary side controller may determine an operation mode of the power converter at block 310. As described above, the appropriate operation mode may be selected form, for example, the CCM mode, QR mode, or DCM modes. The primary side controller may determine an operation mode of the power converter based on the operating condition, such as the input and output voltage levels, the output power level, and the like. In some examples, the primary side controller may determine the operation mode of the power converter based on an instruction from another controller, such as a system-level controller.

At block 312, the primary side controller may generate a model control signal based on the operation mode. For example, if the selected operation mode is the CCM mode, the primary side controller may generate a mode control signal that may include one pulse in a switch cycle, where the timing of the pulse may indicate the timing for switching off the rectifier switch and switching on the primary switch. If the selected operation mode is the QR mode, the primary side controller may generate a mode control signal that may include two pulses in a switch cycle to indicate that the primary switch is to be switched on at the first valley of the resonant ring at the terminal of the primary switch. If the selected operation mode is a DCM mode, the primary side controller may generate a mode control signal that may include three or more pulses in a switch cycle to indicate that the primary switch is to be switched on at the second or a subsequent valley of the resonant ring at the terminal of the primary switch. For example, if the mode control signal includes three pulses in a switch cycle, the primary switch is to be switched on at the second valley of the resonant ring at the terminal of the primary switch. If the mode control signal includes five pulses in a switch cycle, the primary switch is to be switched on at the fourth valley of the resonant ring at the terminal of the primary switch.

At block 314, the primary side controller may transmit a communication signal representing the mode control signal, via a transmitter and an isolation channel, to the secondary side controller. The isolation channel may be a one-way communication channel, where a signal may be transmitted from the primary side controller to the secondary side controller, without a direct current path between the primary side controller and the secondary side controller. For example, the isolation channel may include a inductive/capacitive communication channel, where the primary side controller and the secondary side controller may be coupled through a transformer (or coupled inductors) or a capacitor. In another example, the isolation channel may be an optical communication channel, where the primary side of the power converter may include, for example, an infrared light transmitter, and the secondary side of the power converter may include an infrared light detector. In yet another example, the isolation channel may be an electromagnetic communication channel, such as a microwave or radio frequency communication channel, where the primary side of the power converter may include a microwave or RF signal transmitter, and the secondary side of the power converter may include a microwave or RF signal receiver.

At block 316, the primary side controller may, based on the operation mode, generate a primary switch control signal to control the switching on and off of the primary switch. For example, as described above, in the CCM mode, the primary side controller may generate a control signal to turn on the primary switch after a certain delay from sending the mode control signal. In the QR and DCM mode, the primary side controller may generate a control signal to turn on the primary switch when a zero voltage level or one or more valleys of the resonant ring at a first terminal (e.g., the drain) of the primary switch are detected, as described in more detail below. The primary side controller may generate a control signal to turn off the primary switch after a certain on time, where the on time of the primary switch in each switch cycle (e.g., the duty cycle of the primary switch) may be selected based on the desired relationship between the input voltage level and the voltage across the primary side winding (sometimes referred to as flyback voltage V_{FLY}) of the coupled inductor, for example, the duty cycle may be determined to be about V_{FLY}/(V_{IN}+V_{FLY}).

The secondary side controller may receive the communication signal representing the mode control signal via the isolation channel at block 320, and process the communication signal to determine the target operation mode of the power converter at block 322. As described above, in one example, the secondary side controller may determine the operation mode based on the number of pulses in a switch cycle of the model control signal. The secondary side controller may then generate a rectifier switch control signal based on the operation mode and/or the communication signal at block 324, to control the rectifier switch based on the rectifier switch control signal at block 326. The rectifier switch control signal may be different for different operation modes, as described in more detail below.

As described above, in the CCM mode, a continuous current is flowing in the coupled inductor during each switch cycle. When the primary switch is turned on, the primary side current may ramp up from a positive initial current (greater than zero) due to residual energy stored in the transformer. The primary side current may store energy in the coupled inductor by magnetizing the coupled inductor. When the primary switch is turned off and the rectifier switch is turned on, the stored energy may be transferred to the secondary side and the coupling inductor may be demagnetized, resulting in a secondary side current that ramps down. But the secondary side current may not ramp down to zero, and thus residual energy may be stored in the coupled inductor when the next switch cycle begins. Thus, in CCM mode, current may always be conducted in at least a portion of the coupled inductor (no dead-time), but the primary switch and the rectifier switch may not conduct at the same time. There is no resonant ringing in CCM mode as the transformer is not fully demagnetized and there is no dead-time in each switch cycle. Flyback converters operate in the CCM mode may have small ripple current and RMS current, which may result in lower capacitor losses and lower conduction and turn-off losses compared with DCM flyback converters. Flyback converters in CCM mode may have a right-half-plane zero in the power stage transfer function, which may limit the bandwidth of the control loop and impact the dynamic response.

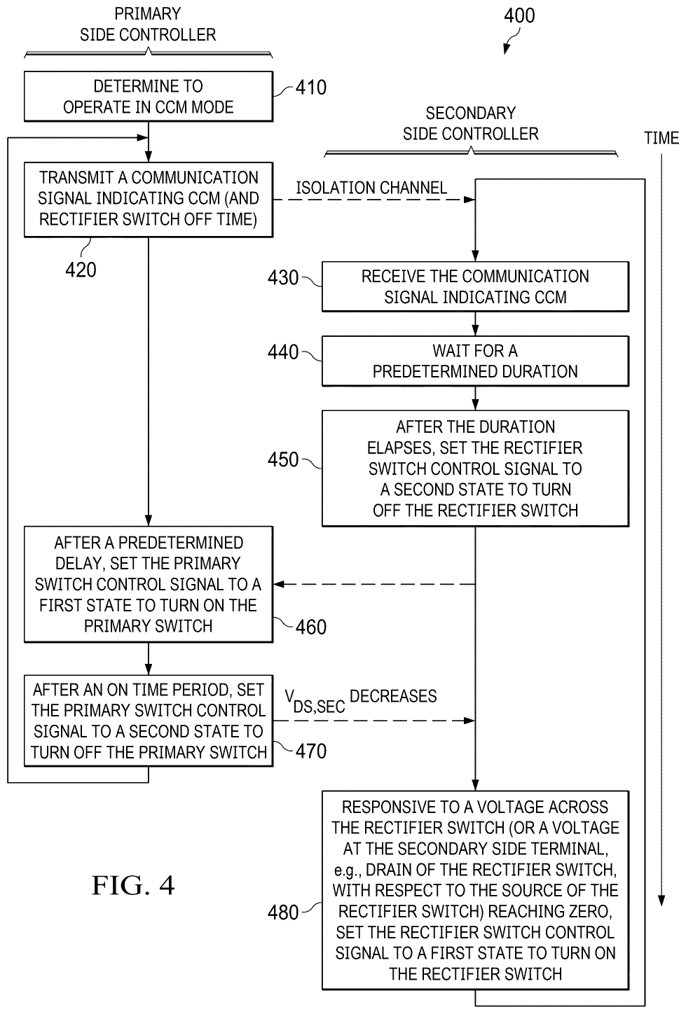

FIG. 4 is a flowchart of an example of a method 400 of controlling a power converter operating in the CCM mode. At block 410, the primary side controller may determine that the power converter is to operate in the CCM mode. At block 420, the primary side controller may transmit, via a transmitter and an isolation channel, a communication signal indicating the CCM mode and the timing for switching off the rectifier switch. As described above, in one example, the communication signal may include one pulse in each switch cycle to indicate the CCM operation mode, where the timing of the pulse may be used to determine the switching time of the primary switch and rectifier switch. The primary side controller may then wait for a predetermined delay time to ensure that the rectifier switch is switched off before turning on the primary switch.

At block 430, the secondary side controller may receive the communication signal from the primary side controller through the isolation channel, and may decode the communication signal to determine that the power converter is to operate in the CCM mode. The secondary side controller may then wait a predetermined duration at block 440, and, after the duration elapses, set the rectifier switch control signal to a state to turn off the rectifier switch at block 450. The predetermined delay time for turning on the primary switch and the predetermined duration before turning off the rectifier switch may be the same or may be different, and they may be selected to ensure that the primary switch would not be turned on before the rectifier switch is turned off. In one example, the predetermined delay time that the primary side controller would wait may be longer that the predetermined duration that the secondary side controller would wait.

At block 460, after the predetermined delay time has elapsed, the primary side controller may set the primary switch control signal to a first state to turn on the primary switch. After an on time period, the primary side controller may set the primary switch control signal to a second state to turn off the primary switch at block 470. As described above, the on time period may be determined based on, for example, a target relationship between the input voltage and the voltage across the primary side winding of the coupled inductor. After the primary switch is turned off, the magnetizing current on the primary side may decrease, and the polarity of the voltage drop on the primary side inductor may be reversed, such that the polarity of the voltage drop across the secondary side winding may also be reversed, as shown in, for example, FIG. 1C. As a result, the voltage across the rectifier switch may drop.

At block 480, the secondary side controller may detect that a voltage across the rectifier switch or a voltage at a secondary side terminal (e.g., a drain of the rectifier switch with respect to a source of the rectifier switch) reaches zero, and may then set the rectifier switch control signal to a state to turn on the rectifier switch. Operations at blocks 420-480 may be performed in each switch cycle in the CCM operation mode.

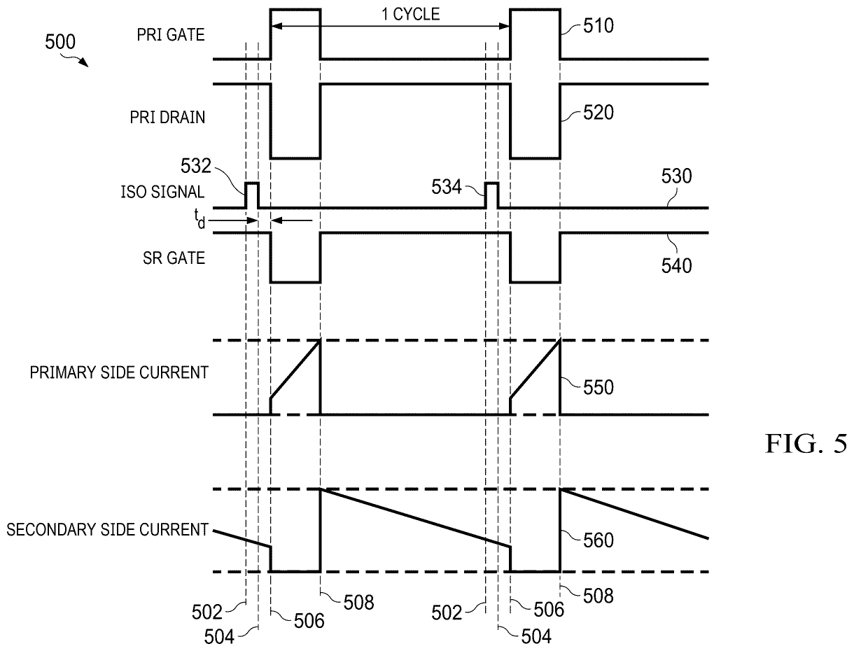

FIG. 5 is a graph 500 illustrating examples of voltage signals and current signals of a power converter (e.g., power converter 100) operating in the continuous conduction mode. FIG. 5 shows two switch cycles in the CCM mode. A waveform 510 shows the voltage at the control terminal of the primary switch (e.g., the gate of a FET on the primary side). A waveform 520 shows the voltage of the first terminal (e.g., terminal 122) of the primary switch (e.g., the drain of the FET on the primary side) that is coupled to the coupled inductor (e.g., coupled inductor 110). A waveform 530 shows the isolation channel signal, a waveform 540 shows the voltage at the control terminal of the rectifier switch (e.g., the gate of a second FET on the secondary side). A waveform 550 shows the current in the primary side of the coupled inductor (e.g., the magnetizing current Iₘ flowing through the magnetizing inductor and the primary switch). A waveform 560 shows the current in the secondary side of the coupled inductor (or the current flowing through the rectifier switch).

In each switch cycle, in a time period between time 502 and time 504, a pulse 532 may be sent from primary side to the secondary side through an isolation channel. At a time 506, which may be at a delay t_{d} from time 504, the voltage at the control terminal of the rectifier switch may be set to a low level to turn off the rectifier switch, and the voltage at the control terminal of the primary switch may be set to a high level to turn on the primary switch. After the primary switch is turned on, the magnetizing current may increase to store energy in the magnetizing inductor. Since the rectifier switch is turned off, the current in the secondary side winding of the coupled inductor may be zero. At time 508, the voltage at the control terminal of the primary switch may be set to a low level to turn off the primary switch. As described above, the on time period or the duty cycle of the primary switch (between time 506 and time 508) in each switch cycle may be determined based on, for example, the desired relationship between the input voltage and the voltage across the primary side winding of the coupled inductor.

After the primary switch is turned off at time 508, the magnetizing current on the primary side may decrease, and the polarity of the voltage drop on the primary side inductor may be reversed, such that the polarity of the voltage drop across the secondary side winding may also be reversed, as shown in, for example, FIG. 1C. As a result, the voltage across the rectifier switch may drop. The rectifier switch may be turned on when the voltage across the rectifier switch reaches zero. Energy stored in the magnetizing inductor during the on time period may then start to be transferred to the secondary side of the coupled inductor, and the current in the secondary side winding of the coupled inductor may be at a peak level right after time 508 and may then linearly decrease. Before the stored energy is completely transferred to the secondary side of the coupled inductor, the rectifier switch may be turned off and the primary switch may be turned on at time 506 in the next switch cycle after a delay time t_{d} from the transmission of a pulse 534 in the next switch cycle. As shown in FIG. 5, the waveforms of the current on both the primary side and the secondary side of the coupled inductor have a trapezoid shape. There is little or no dead-time in the CCM mode as current is continuously being conducted in either the primary side winding or the secondary side winding of the coupled inductor.

As described above, for a flyback power converter operating in the DCM mode, during the on time of the power converter, the primary side current may ramp up and the energy may be stored in the magnetizing inductor. During the off time, the energy stored in the magnetizing inductor may be transferred to the secondary side and the magnetizing inductor may be demagnetized. The current in the secondary side winding may have a peak value that may depend on the turns ratio of the coupled inductor and may ramp down to zero. After the secondary side current ramps down to zero, there may be a time period before the primary switch is turned on again to start the next switch cycle. During this time period of a switch cycle, neither the primary switch nor the secondary switch is conducting, but a resonant ring may be generated during this time period due to, for example, the interaction between the inductance of the coupled inductor and the parasitic capacitance of the rectifier switch. Valley switching techniques may be used to detect the low point (e.g., valley) of the resonant ring so that the primary switch may be turned on to start the next switch cycle when the voltage level at the first terminal of the primary switch is at a low level, thereby minimizing switching losses. Valley switching can occur at any valley of the resonant ring. Quasi-resonant (QR) mode is one example of a DCM mode, where the switching may occur on the first valley of the resonant ring.

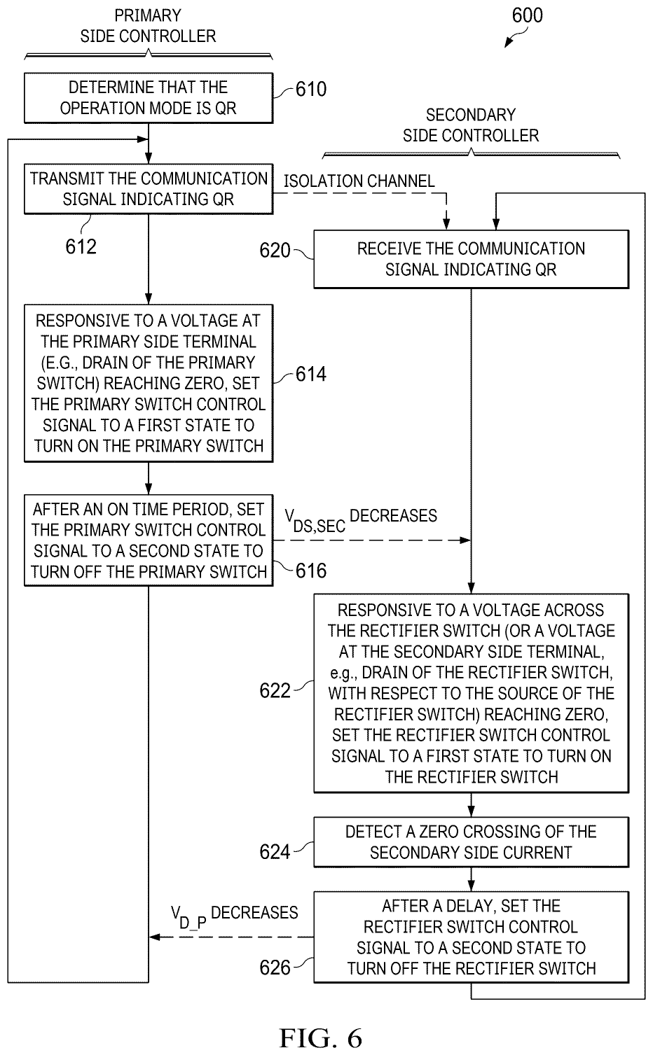

FIG. 6 is a flowchart of an example of a method 600 of controlling a power converter operating in a quasi-resonant mode. At block 610, the primary side controller may determine that the power converter is to operate in the QR mode. At block 612, the primary side controller may transmit, via a transmitter and an isolation channel, a communication signal indicating the QR mode and the timing for switching off the rectifier switch. In one example, the communication signal may include two pulses in each switch cycle to indicate the QR operation mode, where the two pulses may be at any time in the switch cycle, such as at any time when the primary switch is in the on state. Thus, operations at block 612 may be performed at any time in each switch cycle. The primary side controller may wait for a voltage at the primary side terminal (e.g., the drain of the primary switch) to reach zero, before setting the primary switch control signal to a first state to turn on the primary switch at block 614. After the primary switch has been turned on for an on time period, the primary side controller may set the primary switch control signal to a second state to turn off the primary switch at block 616. As described above, the on time period may be determined based on, for example, a target relationship between the input voltage and the voltage across the primary side winding of the coupled inductor.

At block 620, the secondary side controller may receive the communication signal from the primary side controller through the isolation channel, and may decode the communication signal to determine that the power converter is to operate in the QR mode. The secondary side controller may then wait for a voltage across the rectifier switch or a voltage at the secondary side terminal (e.g., drain of the rectifier switch) to reach zero, before setting a rectifier switch control signal to a first state to turn on the rectifier switch at block 622. After turning on the rectifier switch, the secondary side controller may monitor the secondary side current that flow through the secondary side winding and the rectifier switch to detect a zero crossing of the secondary side current at block 624. If a zero crossing of the secondary side current is detected, the secondary side controller may wait a pre-determined delay time and then set the rectifier switch control signal to a second state to turn off the rectifier switch at block 626. Operations at blocks 612 and 626 may be performed in each switch cycle of the QR operation mode of the power converter.

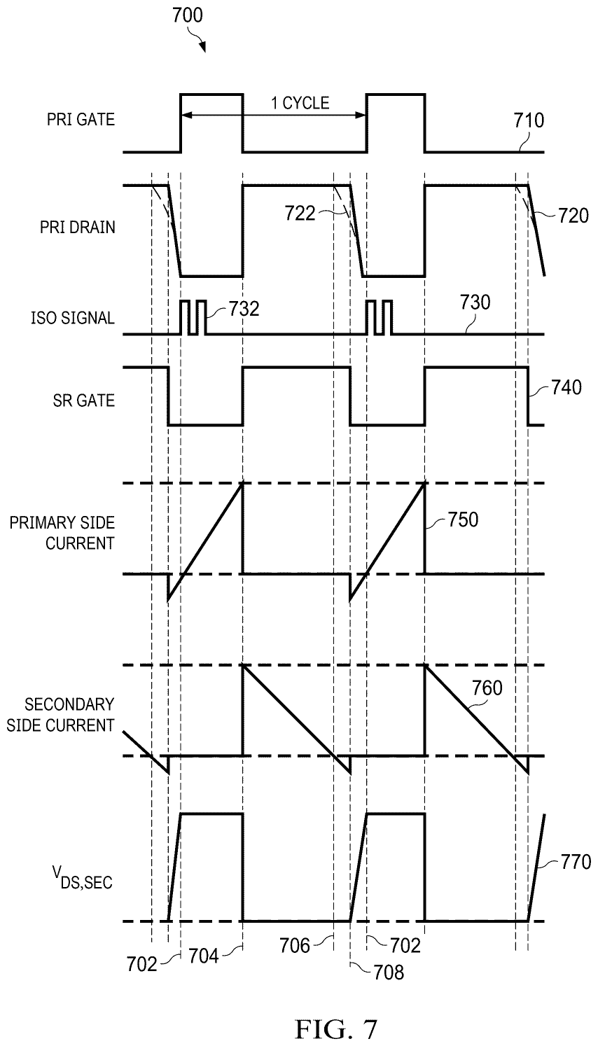

FIG. 7 is a graph 700 illustrating examples of voltage signals and current signals of a power converter (e.g., power converter 100) operating in the quasi-resonant mode. A waveform 710 in graph 700 shows the voltage at the control terminal of the primary switch (e.g., the gate of a FET on the primary side). A waveform 720 shows the voltage of the first terminal of the primary switch (e.g., the drain of the FET on the primary side) that is coupled to the coupled inductor. A waveform 730 shows the isolation channel signal. A waveform 740 shows the voltage at the control terminal of the rectifier switch (e.g., the gate of a second FET on the secondary side). A waveform 750 shows the current in the primary side winding of the coupled inductor (e.g., the magnetizing current Iₘ flowing through the magnetizing inductor and the primary switch). A waveform 760 shows the current in the secondary side winding of the coupled inductor (or the current flowing through the rectifier switch). A waveform 770 shows the voltage of a terminal of the rectifier switch (e.g., the drain of a FET switch) with respect to the voltage of another terminal of the rectifier switch (e.g., the source of the FET switch).

In each switch cycle, the isolation channel signal may include two pulses 732 to indicate that the power converter is to operate in the QR mode. The two pulses 732 may be transmitted at any time in the switch cycle, such as at any time when the primary switch is in the on state. At time 702, the voltage of the first terminal (e.g., the drain) of the primary switch may reach zero, and the primary side controller may turn on the primary switch by driving the control terminal of the primary switch with a high voltage level. Thus, the current in the primary side of the coupled inductor (e.g., the magnetizing current Iₘ) may linearly increase to magnetize the primary side inductor as shown by waveform 750. At time 702, the rectifier switch is in the off state. Therefore, the energy in the primary side inductor may not be transferred to the secondary side of the coupled inductor, and the drain voltage of the rectifier switch with respect to the source of the rectifier switch may be high.

At a time 704, the primary side controller may drive the control terminal of the primary switch to a low voltage level to turn off the primary switch after an on time period. As described above, the on time period of the primary switch may be determined based on, for example, a target relationship between the input voltage and the voltage across the primary side winding of the coupled inductor. When the primary switch is turned off, the polarity of the voltage across the primary side winding and the voltage across the secondary side winding may reverse, and thus the voltage at the drain of the primary switch may increase to a high level (e.g., about V_{IN}+N×V_{OUT}) and the voltage level at the drain of the rectifier switch with respect to the source of the rectifier switch may drop to zero. The secondary side controller may sense the zero voltage across the rectifier switch and turn on the rectifier switch at around time 704. When the rectifier switch is turned on, energy stored in the primary side inductor may be transferred to the secondary side of the coupled inductor, and the current in the secondary side winding may be at a peak level first and then gradually decrease as the primary side inductor is gradually demagnetized.

At time 706, the current in the secondary side winding may ramp down to zero. The rectifier switch can be turned off at this time so that the voltage at the drain of the primary switch may start to decrease in the dead-time as shown by a dashed line 722. However, if the rectifier switch is turned off at time 706, a resonant ringing may occur in the current of the secondary side winding and the current of the primary side winding due to the interaction between the inductance of the coupled inductor and the parasitic capacitance of the rectifier switch, and the voltage level at the drain of the primary switch may also oscillate and may not reach zero (if V_{IN}>N×V_{OUT}) to achieve zero voltage switching. Therefore, as described above, in order to achieve zero voltage switching, the rectifier switch may be kept in the on state for an additional time period between time 706 and time 708, so that the current in the secondary side winding may continue to decrease and become negative during this time period. The longer the delay between time 706 and time 708, the lower the negative current in the secondary side winding may be.

At time 708, the rectifier switch may be turned off, and the negative current in the secondary side winding of the coupled inductor may cause a negative current in the primary side winding, such that the drain of the primary switch may be further discharged. The negative current in the primary side winding may gradually ramp up. The lower the negative current in the secondary side winding at time 708, the longer it may take for the current in the secondary side winding to ramp up to zero, and thus the longer the drain of the primary switch may be discharged. Thus, when the delay between time 706 and time 708 is appropriate, the current in the primary side winding may remain negative to fully discharge the drain of the primary switch in the time period between time 708 and time 702 of the next switch cycle, before the current in the primary side winding become positive. At time 702 of the next switch cycle, the primary side controller may detect the zero voltage at the drain of the primary switch, and may drive the gate of the primary switch with a high voltage level to turn on the primary switch for the next switch cycle.

As described above, in the DCM mode, during the on time of each switch cycle, the primary side current may ramp up from zero to magnetize the transformer. After the on time ends, the primary side current may decrease, and current may start to flow in the secondary side winding to demagnetize the coupled inductor, charge the output capacitor, and drive the load. The current in the secondary side winding may begin at a peak that may be proportional to the turns ratio of the coupled inductor and may ramp down to zero to completely demagnetize the transformer during every switch cycle. After the demagnetizing period, there may be a time period before the primary switch is turned on again to start the next switch cycle. This time period may be referred to as dead-time or resonant time. During this time period of a switch cycle, neither the primary switch nor the rectifier switch is conducting (hence discontinuous conduction), and the coupled inductor may be completely demagnetized. But a resonant ring may be generated during this time period, for example, due to the interaction between the inductance of the coupled inductor and the parasitic capacitance of the rectifier switch. In order to minimize switching losses, valley switching techniques can be used to turn on the primary switch when the voltage level at the first terminal (e.g., drain) of the primary switch is at a low level. For example, a controller may be used to detect when the resonant ring is at a low point (e.g., a valley) before turning on the primary switch again to start the next switch cycle. The valley of the resonant ring may have a voltage level that is about V_{IN}−N×V_{OUT} (where the turns ratio of the transformer is N:1), which may be greater than zero. Therefore, the power converter may not achieve zero voltage switching.

According to some examples disclosed herein, the current in the secondary side winding may be controlled by controlling the switch timing of the rectifier switch so that the current in the secondary side winding may reduce from a positive current at the beginning of the off state down to a zero current and then further down to become negative. The negative secondary side current may cause a negative current in the primary side winding through the coupled inductor. The negative current in the primary side winding caused by the negative current in the secondary side winding may discharge the first terminal (e.g., drain) of the primary switch to reduce the voltage at the first terminal. When the negative current is appropriate, it may completely discharge the first terminal down to zero volts before ramping up to a positive current, thereby achieve zero voltage switching to reduce switching loss and improve efficiency. The negative current in the secondary side winding may be achieved by, for example, delaying the switching off of the rectifier switch by a certain time period after the detection of a zero crossing of the current in the secondary side winding and the rectifier switch, to allow the current in the secondary side winding to further reduce to a negative current. The delay time (and thus the peak value of the negative current) may be selected such that the drain voltage of the primary switch may reach zero volts before the primary switch is switched on in the next switch cycle. In this way, ZVS of the primary switch can be achieved.

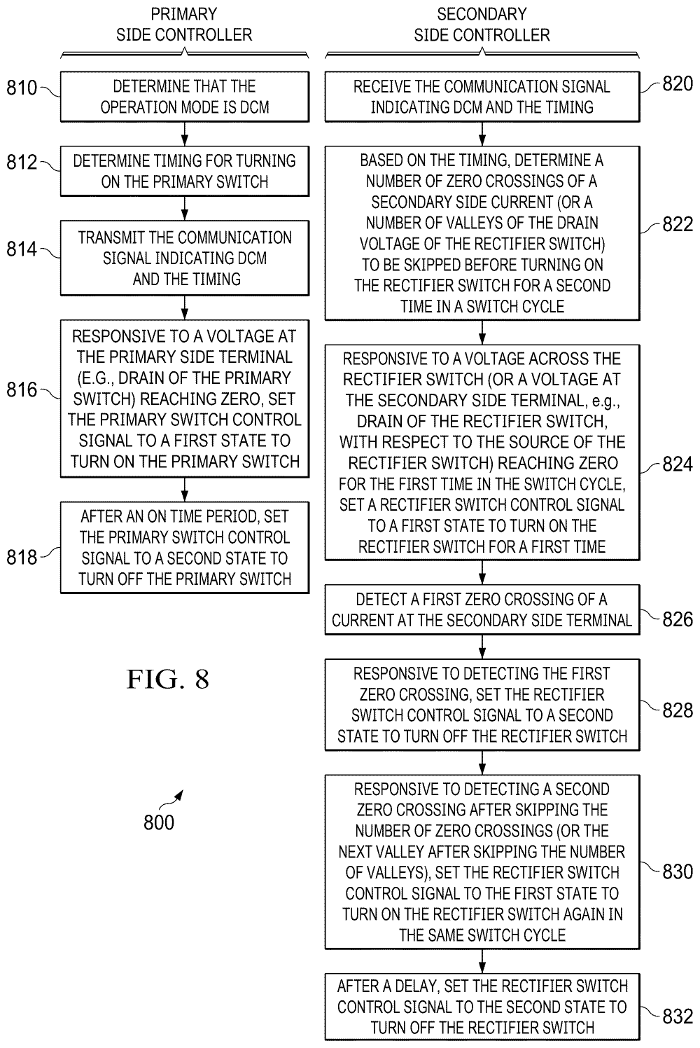

FIG. 8 is a flowchart of an example of a method 800 of controlling a power converter operating in a DCM mode. At block 810, the primary side controller may determine that the power converter is to operate in the DCM mode. At block 812, the primary side controller may determine the timing for turning on the primary switch based on, for example, a target average output current of the power converter. For example, the primary side controller may determine the number of valleys of the resonant ring to skip before turning on the primary switch. As described above, in some examples, the primary side controller may receive instructions from another controller regarding the operation mode and/or the timing for turning on the primary switch. At block 814, the primary side controller may transmit, via a transmitter and an isolation channel, a communication signal indicating the DCM mode and the timing for switching off the rectifier switch. In one example, the communication signal may include three or more pulses in each switch cycle to indicate the DCM operation mode, where the three or more pulses may be at any time in the switch cycle. The number of pulses may indicate the number of valleys of the resonant ring of the drain voltage of the primary switch to be skipped before turning on the primary switch. For example, when the communication signal includes three pulses in each switch cycle, the primary switch may be turned on at the second valley (skipping one valley) of the resonant ring of the drain voltage of the primary switch. When the communication signal includes four pulses in each switch cycle, the primary switch may be turned on at the third valley (skipping two valleys) of the resonant ring of the drain voltage of the primary switch. When the communication signal includes five pulses in each switch cycle, the primary switch may be turned on at the fourth valley (skipping three valleys) of the resonant ring of the drain voltage of the primary switch, and so on. Operations at block 814 may be performed at any time in each switch cycle.

The primary side controller may then wait for a voltage at the first terminal the primary switch (e.g., the drain of the primary switch, which may be coupled to a primary side terminal of the coupled inductor) to reach zero volts, before setting the primary switch control signal to a first state to turn on the primary switch at block 816. After the primary switch has been turned on for an on time period, the primary side controller may set the primary switch control signal to a second state to turn off the primary switch at block 818. As described above, the on time period may be determined based on, for example, a target relationship between the input voltage and the voltage across the primary side winding of the coupled inductor.

At block 820, the secondary side controller may receive the communication signal from the primary side controller through the isolation channel, and may decode the communication signal to determine that the power converter is to operate in the DCM mode and determine the switch timing of the power converter (e.g., the number of valleys to skip). At block 822, the secondary side controller may determine, based on the determined switch timing of the power converter, a number of valleys of the drain voltage of the rectifier switch (or a number of zero crossings of the current of the secondary side winding and the rectifier switch) to be skipped before turning on the rectifier switch for a second time in a switch cycle. The secondary side controller may then wait for a voltage across the rectifier switch or a voltage at a secondary side terminal (e.g., the drain of the rectifier switch) to reach zero, before setting a rectifier switch control signal to a first state to turn on the rectifier switch at block 822 for the first time in the switch cycle. After turning on the rectifier switch, the secondary side controller may monitor the current at the secondary side terminal (e.g., the current flowing in the secondary side winding and the rectifier switch) to detect a zero crossing of the current at the secondary side terminal at block 824. When a zero crossing of the current at the secondary side terminal is detected at block 826, the secondary side controller may set the rectifier switch control signal to a second state to turn off the rectifier switch for the first time in the switch cycle at block 828.

The secondary side controller may continue to monitor the current at the secondary side terminal to detect zero crossings of the current at the secondary side terminal or the valleys of the resonant ring of the voltage at the secondary side terminal (e.g., the drain voltage of the rectifier switch). At block 830, in response to detecting a next zero crossing of the current at the secondary side terminal after skipping the determined number of zero crossings of the current, or detecting the next valley after skipping the determined number of valleys of the voltage at the drain of the rectifier switch relative to the source of the rectifier switch, the secondary side controller may set the rectifier switch control signal to the first state to turn on the rectifier switch again in the same switch cycle. The secondary side controller may wait a pre-determined delay time and then set the rectifier switch control signal to the second state to turn off the rectifier switch again at block 832. Operations at blocks 812 and 826 may be performed in each switch cycle of the DCM operation mode of the power converter.

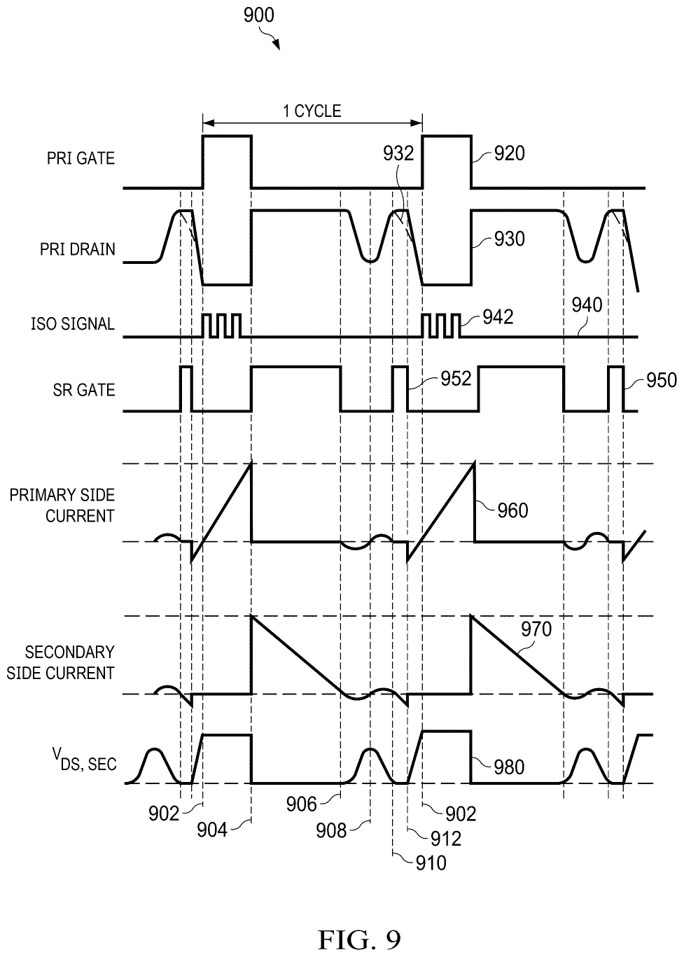

FIG. 9 is a graph 900 illustrating examples of voltage signals and current signals of a power converter operating in the discontinuous conduction mode. A waveform 920 in graph 900 shows the voltage at the control terminal of the primary switch (e.g., the gate of a FET on the primary side). A waveform 930 shows the voltage of the first terminal of the primary switch (e.g., the drain of the FET on the primary side) that is coupled to the coupled inductor. A waveform 940 shows the isolation channel signal. A waveform 950 shows the voltage at the control terminal of the rectifier switch (e.g., the gate of a second FET on the secondary side). A waveform 960 shows the current in the primary side winding of the coupled inductor (e.g., the magnetizing current Iₘ flowing through the magnetizing inductor and the primary switch). A waveform 970 shows the current in the secondary side winding of the coupled inductor (or the current flowing through the rectifier switch). A waveform 980 shows the voltage of a terminal of the rectifier switch (e.g., the drain of a FET switch) with respect to the voltage of another terminal of the rectifier switch (e.g., the source of the FET switch).

In the illustrated example, in each switch cycle, the isolation channel signal may include three pulses 942 to indicate that the power converter is to operate in the DCM mode and the primary switch is to be turned on after the second valley of the resonant ring of the voltage at the first terminal of the primary switch. The three pulses 942 may be transmitted at any time during the switch cycle, such as at any time when the primary switch is in the on state. At a time 902, the voltage of the first terminal of the primary switch may reach zero volts, and the primary side controller may turn on the primary switch by driving the control terminal of the primary switch with a high voltage level. Thus, the current in the primary side of the coupled inductor (e.g., the magnetizing current Iₘ) may linearly increase to magnetize the primary side inductor as shown by waveform 960. At time 902, the rectifier switch is in the off state. Therefore, the energy stored in the primary side inductor may not be transferred to the secondary side of the coupled inductor, and the drain voltage of the rectifier switch with respect to the source of the rectifier switch may be high.

At a time 904, the primary side controller may drive the control terminal of the primary switch with a low voltage level to turn off the primary switch after an on time period. As described above, the on time period (or the duty cycle) of the primary switch may be determined based on, for example, the desired relationship between the input voltage and the voltage across the primary side winding of the coupled inductor. When the primary switch is turned off, the polarity of the voltage across the primary side winding and the voltage across the secondary side winding may be reversed, and thus the voltage at the drain of the primary switch may increase to a high level (e.g., about V_{IN}+N×V_{OUT}) and the voltage level at the drain of the rectifier switch with respect to the source of the rectifier switch may drop to zero. The secondary side controller may detect the zero voltage across the rectifier switch and turn on the rectifier switch. When the rectifier switch is turned on, energy stored in the primary side inductor may be transferred to the secondary side of the coupled inductor, and the current in the secondary side winding may be at a peak level first and then gradually decrease as the primary side inductor is gradually demagnetized.

At a time 906, the current in the secondary side winding may ramp down to zero. The secondary side controller may drive the gate of the rectifier switch with a low voltage level to turn off the rectifier switch for the first time in the switch cycle at around time 906. After the rectifier switch is turned off at time 906, both the primary switch and the rectifier switch are in the off state and would not conduct current. As described above, a resonant ring may be generated in the current of the secondary winding and the current of the primary side winding due to the interaction between the inductance of the coupled inductor and the parasitic capacitance of the rectifier switch. The negative current in the primary side winding may discharge the drain of the primary switch, while a positive current in the primary side winding may charge the drain of the primary switch. Thus, the voltage at the drain of the primary switch may also have a resonant ring. The valley of the resonant ring at the drain of the primary switch may be about V_{IN}−N×V_{OUT}, and may not reach zero if V_{IN}>N×V_{OUT}.

At a time 908, the resonant ring of the current in the primary side winding and the secondary side winding may reach zero again from a negative current value, and the voltage at the drain of the primary switch may reach a valley, while the voltage at the drain of the rectifier switch may reach a peak. The current and voltage at the drain of each of the primary switch and the rectifier switch may continue to oscillate.

At a time 910, the resonant ring of the current in the primary side winding and the secondary side winding may reach zero again from a positive current value, and the voltage at the drain of the primary switch may reach a peak, while the voltage at the drain of the rectifier switch may reach a valley. If the primary switch is turned on at time 910, the voltage at the drain of the primary switch may start to decrease as shown by a dashed line 932. However, if the primary switch is turned on at time 910, the voltage at the drain of the primary switch may not reach zero to achieve zero voltage switching if V_{IN}>N×V_{OUT}. As described above, in order to achieve zero voltage switching, the secondary side controller may drive the gate of the rectifier switch with a high voltage level at time 910 to turn on the rectifier switch for the second time in the switch cycle, so that the rectifier switch may be conducting to allow the current in the secondary side winding to ramp down and become negative. Since the rectifier switch is turned on, the resonance caused by the inductance of the coupled inductor and the parasitic capacitance of the rectifier switch may stop. The rectifier switch may be kept in the on state for a time period between time 910 and a time 912 as shown by a pulse 952, so that the current in the secondary side winding may continue to decrease and become a large negative current at the end of this time period. The longer the duration of pulse 952, the lower the current in the secondary side winding may become. The duration of pulse 952 may be pre-determined as described in more detail below to cause an appropriate peak negative current in the secondary side winding at the end of pulse 952 (e.g., time 912)

At time 912, the secondary side controller may, after keeping the rectifier switch on for the pre-determined duration shown by pulse 952, turn off the rectifier switch. The negative current in the secondary side winding of the coupled inductor may cause a negative current in the primary side winding, such that the drain of the primary switch may be discharged. The negative current in the primary side winding may gradually ramp up. The lower the negative current in the secondary side winding before time 912, the longer it may take for the current in the primary side winding to ramp up to zero, and thus the longer the drain of the primary switch may be discharged. Therefore, when the duration of pulse 952 is appropriate, the current in the primary side winding may remain negative in the time period between time 912 and time 902 of the next switch cycle to fully discharge the drain of the primary switch, before the current in the primary side winding may become positive to charge the drain of the primary switch. At time 902 of the next switch cycle, the primary side controller may detect a zero voltage at the drain of the primary switch, and may drive the gate of the primary switch with a high voltage level to turn on the primary switch.

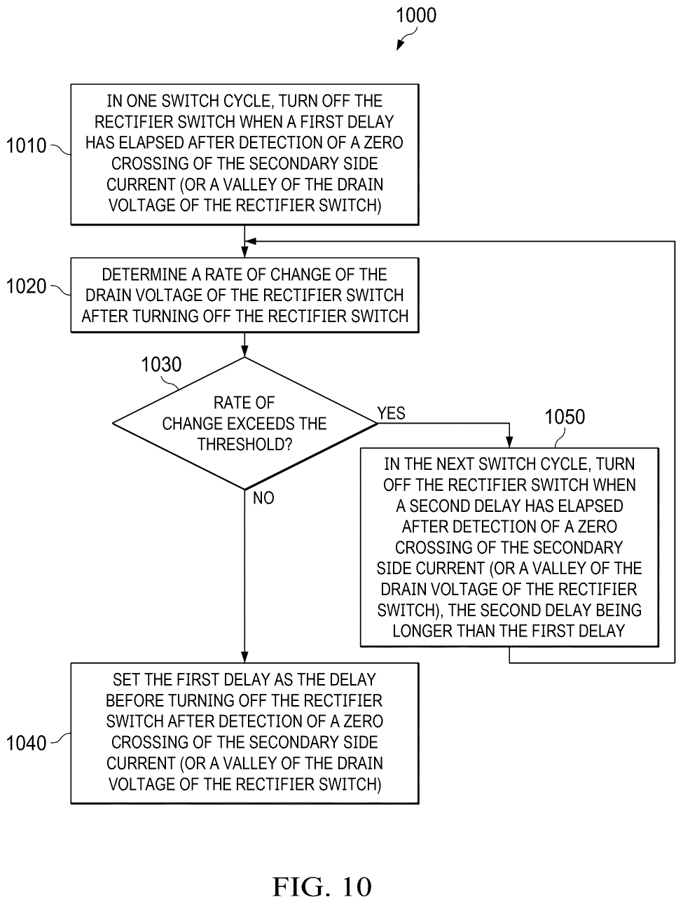

FIG. 10 is a flowchart illustrating an example of a process 1000 of adjusting the negative secondary side current to achieve ZVS of the primary switch. The adjustment can be based on, for example, adjusting a delay time from detecting a valley of a voltage of a secondary side terminal (or a zero crossing of a secondary side current) of a power converter before turning off the rectifier switch of the power converter. The delay time can represent, for example, the second pulse width of the rectifier switch in DCM mode (e.g., pulse 952 of FIG. 9), the delay between detection of zero crossing of secondary side current and the turning off the rectifier switch in QR mode, etc.

Operations in flowchart 1000 may be performed by the secondary side controller during the setup or initialization of the power converter or during operations of the power converter. At block 1010, after the rectifier switch is turned on for the second time in a switch cycle, the secondary side controller may turn off the rectifier switch when a first delay has elapsed from the detection of a zero crossing of the secondary side current (or a valley of the drain voltage of the rectifier switch or the voltage across the rectifier switch). The negative current in the secondary side winding may cause a negative current in the primary side winding of the coupled inductor of the power converter to discharge the drain of the primary switch, and thus the voltage at the drain of the primary switch may decrease, while the voltage at the drain of the rectifier switch may increase. When the first delay is short, the peak negative current in the primary side winding may be small and the current in the primary side winding may ramp up to zero soon, and thus the negative current in the primary side winding may not fully discharge the drain of the primary switch, such that the voltage at the drain of the primary switch may not reach zero and the voltage at the drain of the rectifier switch may not reach its peak. When the primary switch is turned on, the voltage at the drain of the primary switch may quickly reach zero volts, and the voltage at the drain of the rectifier switch may quickly reach its peak. Thus, the voltage at the drain of the rectifier switch may have a large slope (dV/dt).

At block 1020, the secondary side controller may monitor the drain voltage (and/or voltage across the drain and the source) of the rectifier switch to determine a rate of change of the drain voltage of the rectifier switch after turning off the rectifier switch. The secondary side controller may compare the rate of change with a threshold at block 1030. If the rate of change of the drain voltage of the rectifier switch does not exceed the threshold, the secondary side controller may set the first delay as the delay from the detection of a zero crossing of the secondary side current or a valley of the drain voltage of the rectifier switch with respect to the source voltage of the rectifier switch (e.g., a valley of the voltage across the rectifier switch) before turning off the rectifier switch at block 1040. The first delay may then be used to achieve zero voltage switching in a DCM or QR operation mode.

If the rate of change of the drain voltage of the rectifier switch exceeds the threshold, the first delay may not be sufficient to cause zero voltage switching at the primary side of the power converter, and a longer delay may be used in the next switch cycle to try to achieve zero voltage switching. For example, at block 1050, the secondary side controller may, in the next switch cycle, turn off the rectifier switch when a second delay has elapsed from the detection of a zero crossing of the secondary side current or a valley of the drain voltage of the rectifier switch with respect to the source voltage of the rectifier switch (e.g., a valley of the voltage across the rectifier switch), where the second delay may be longer than the first delay. The secondary side controller may perform operations at blocks 1020, 1030, and 1040/1050 iteratively to determine an appropriate delay time. In some examples, the second delay may be an incremental step longer than the first delay so that the appropriate delay time may be determined by a linear search. In some examples, the second delay may be much longer than the first delay and may achieve the zero voltage switching, and the appropriate delay time may be determined by a binary search.

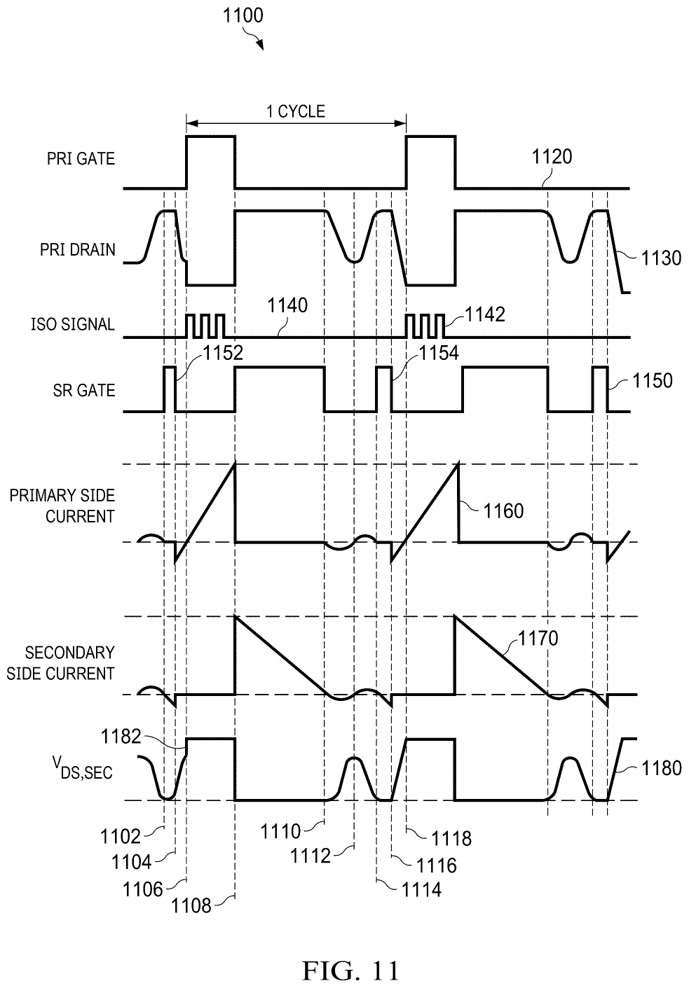

FIG. 11 is a graph 1100 illustrating examples of voltage signals and current signals of a power converter while performing the process of FIG. 10. A waveform 1120 in graph 1100 shows the voltage at the control terminal of the primary switch (e.g., the gate of a FET on the primary side). A waveform 1130 shows the voltage of the first terminal of the primary switch (e.g., the drain of the FET on the primary side) that is coupled to the coupled inductor. A waveform 1140 shows the isolation channel signal. A waveform 1150 shows the voltage at the control terminal of the rectifier switch (e.g., the gate of a second FET on the secondary side). A waveform 1160 shows the current at a primary side terminal of the coupled inductor (e.g., the magnetizing current Iₘ flowing through the magnetizing inductor and the primary switch). A waveform 1170 shows the current in the secondary side winding of the coupled inductor (or the current flowing through the rectifier switch). A waveform 1180 shows the voltage of a terminal of the rectifier switch (e.g., the drain of a FET switch) with respect to the voltage of another terminal of the rectifier switch (e.g., the source of the FET switch). In the illustrated example, in each switch cycle, the isolation channel signal shown by waveform 1140 may include three pulses 1142 to indicate that the power converter is to operate in the DCM mode and the primary switch is to be turned on after the second valley of the resonant ring of the voltage at the first terminal of the primary switch. The three pulses 1142 may be transmitted at any time during the switch cycle, such as during the on time of the primary switch.

Before a time 1102, both the primary switch and the rectifier switch are in the off state and would not conduct current. A resonant ring may be generated in the current of the secondary side winding and the current of the primary side winding due to the interaction between the inductance of the coupled inductor and the parasitic capacitance of the rectifier switch. The negative current in the primary side winding may discharge the drain of the primary switch, while a positive current in the primary side winding may charge the drain of the primary switch. Thus, the voltage level at the drain of the primary switch may also have a resonant ring. The valley of the resonant ring at the drain of the primary switch may be about V_{IN}−N×V_{OUT}, and may not reach zero if V_{IN}>N×V_{OUT}. Similarly, the voltage level at the drain of the rectifier switch may also form a resonant ring.

At time 1102, the resonant ring of the current in the primary side winding and the secondary side winding may reach zero from a positive current value, and the voltage at the drain of the primary switch may reach a peak while the voltage at the drain of the rectifier switch may reach a valley. The secondary side controller may drive the gate of the rectifier switch with a high voltage level at time 1102 to turn on the rectifier switch for the second time in the switch cycle, so that the rectifier switch may be conducting to allow the current in the secondary side winding to ramp down and become negative. Since the rectifier switch is turned on, the resonance caused by the inductance of the coupled inductor and the parasitic capacitance of the rectifier switch may stop. The rectifier switch may be kept in the on state for a first delay time 1152 between time 1102 and a time 1104, so that the current in the secondary side winding may continue to decrease and become a larger negative current during the first delay time 1152. The longer the first delay time 1152, the lower the negative current in the secondary side winding may be. In the illustrated example, the first delay time 1152 may be relatively short, and thus the negative current in the secondary side winding at the end of first delay time 1152 (e.g., at time 1104) may have a small amplitude.

At time 1104, the secondary side controller may set the drive signal at the gate of the rectifier switch to a low level to turn off the rectifier switch. The negative current in the secondary side winding of the coupled inductor may cause a negative current in the primary side winding, such that the drain of the primary switch may be discharged. Therefore, the voltage at the drain of the primary switch may decrease, while the voltage at the drain of the rectifier switch may increase. The negative current in the primary side winding may gradually ramp up. The lower the negative current in the secondary side winding before time 1104, the longer it may take for the current in the primary side winding to ramp up to zero, and thus the longer the drain of the primary switch may be discharged. When the first delay time 1152 is short, the peak negative current in the primary side winding may be small and the current in the primary side winding may ramp up to zero soon, and thus the negative current in the primary side winding may not fully discharge the drain of the primary switch, such that the voltage at the drain of the primary switch may not reach zero and the voltage at the drain of the rectifier switch may not reach its peak. When the primary switch is turned on at a time 1106, the voltage at the drain of the primary switch may quickly drop to zero, and the voltage at the drain of the rectifier switch may quickly reach its peak as shown by a steep line 1182 in waveform 1180. Thus, the voltage at the drain of the rectifier switch may have a large slope that may exceed a threshold rate of change value.

At a time 1108, the primary side controller may drive the control terminal of the primary switch with a low voltage level to turn off the primary switch after an on time period. As described above, the on time period of the primary switch may be determined based on, for example, a target relationship between the input voltage and the voltage across the primary side winding of the coupled inductor. When the primary switch is turned off, the polarity of the voltage across the primary side winding and the voltage across the secondary side winding may reverse, and thus the voltage at the drain of the primary switch may increase to a high level (e.g., about V_{IN}+N×V_{OUT}) and the voltage level at the drain of the rectifier switch with respect to the source of the rectifier switch may drop to zero. The secondary side controller may detect the zero voltage across the rectifier switch and turn on the rectifier switch. When the rectifier switch is turned on, energy stored in the primary side inductor may be transferred to the secondary side of the coupled inductor to charge the output capacitor and drive the load, and the current in the secondary side winding may be at a peak first and then gradually decrease as the primary side inductor is gradually demagnetized.

At a time 1110, the current in the secondary side winding may ramp down to zero. The secondary side controller may drive the gate of the rectifier switch with a low voltage level to turn off the rectifier switch for the first time in the switch cycle at time 1110. After the rectifier switch is turned off at time 1110, both the primary switch and the rectifier switch are in the off state and would not conduct current. As described above, a resonant ring may be generated in the current of the secondary side winding and the current of the primary side winding due to the interaction between the inductance of the coupled inductor and the parasitic capacitance of the rectifier switch. The negative current in the primary side winding may discharge the drain of the primary switch, while a positive current in the primary side winding may charge the drain of the primary switch. Thus, the voltage at the drain of the primary switch may also have a resonant ring. The valley of the resonant ring at the drain of the primary switch may be about V_{IN}−N×V_{OUT}, and may not reach zero if V_{IN}>N×V_{OUT}.

At a time 1112, the resonant ring of the current in the primary side winding and the secondary side winding may reach zero again from a negative current value, and the voltage level at the drain of the primary switch may reach a valley while the voltage level at the drain of the rectifier switch may reach a peak. The current and voltage at the drain of each of the primary switch and the rectifier switch may continue to oscillate.

At a time 1114, the resonant ring of the current in the primary side winding and the secondary side winding may reach zero again from a positive current value, and the voltage at the drain of the primary switch may reach a peak while the voltage at the drain of the rectifier switch may reach a valley. In order to achieve zero voltage switching, the secondary side controller may drive the gate of the rectifier switch with a high voltage level at time 1114 to turn on the rectifier switch for the second time in the switch cycle, so that the rectifier switch may be conducting to allow the current in the secondary side winding to ramp down and become negative. Since the rectifier switch is turned on, the resonance caused by the inductance of the coupled inductor and the parasitic capacitance of the rectifier switch may stop. The rectifier switch may be kept in the on state for a second delay time 1154 between time 1114 and a time 1116, so that the current in the secondary side winding may continue to decrease and become a larger negative current during this time period. The second delay time 1154 may be longer than the first delay time 1152, and thus the negative current in the secondary side winding at time 1116 may have a high amplitude than the negative current in the secondary side winding at time 1104.

At time 1116, the secondary side controller may, after keeping the rectifier switch on for the second delay time 1154, turn off the rectifier switch. The negative current in the secondary side winding of the coupled inductor may cause a negative current in the primary side winding, such that the drain of the primary switch may be discharged. The negative current in the primary side winding may gradually ramp up. The lower the negative current in the secondary side winding before time 1116, the longer it may take for the current in the primary side winding to ramp up to zero, and thus the longer the drain of the primary switch may be discharged. In the illustrated example, the second delay time 1154 may be sufficiently long, and thus the current in the primary side winding may remain negative to fully discharge the drain of the primary switch in the time period between time 1116 and a time 1118, before the current in the primary side winding may become positive to charge the drain of the primary switch. Thus, the voltage at the drain of the primary switch may reach zero and the voltage at the drain of the rectifier switch may reach its peak before or at time 1118. At time 1118, the primary side controller may drive the gate of the primary switch with a high voltage level to turn on the primary switch while the drain of the primary switch is at 0 volts and the drain of the rectifier switch may have reached its peak. Therefore, the slope of the voltage at the drain of the rectifier switch may not have a large value that may exceed the threshold rate of change value. As such, the second delay time 1154 may be used as the delay time to achieve zero voltage switching in the DCM modes. In examples where the second delay time 1154 is much longer than the first delay time 1152, a delay value between the first delay time 1152 and the second delay time 1154 may be used in the next switch cycle to fine tune the appropriate delay time.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of at least a part of Y and any number of other factors. If an action X is “based on” Y, then the action X may be based at least in part on at least a part of Y.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter.

References herein to a FET being “on” or “enabled” means that the conduction channel of the FET is present and drain current I_{D} (or drain-to-source current I_{DS}) may flow through the FET. References herein to a FET being “off” or “disabled” means that the conduction channel is not present so drain current does not flow through the FET. An “off” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description.

In this description, unless otherwise stated, “about,” “approximately” or “substantially” preceding a parameter means being within +/−10 percent of that parameter or, if the parameter is zero, a reasonable range of values around zero.

Terms “and” and “or,” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Although various examples have been described in detail, it should be understood that various changes, substitutions, and alterations can be made therein without departing from the scope defined by the appended claims. The devices, structures, materials, and processes discussed above are examples. Various examples may omit, substitute, or add various procedures or components as appropriate. Also, features described with respect to certain examples may be combined in various other examples. Different aspects and elements of the examples may be combined in a similar manner. Also, technology evolves and, thus, many of the elements are examples that do not limit the scope of the disclosure to those specific examples.

Specific details are given in the description on order to provide a thorough understanding of the examples. However, examples may be practiced without these specific details. For example, well-known circuits, processes, systems, structures, and techniques may have been shown without unnecessary detail in order to avoid obscuring the examples. This description provides examples only, and is not intended to limit the scope, applicability, or configuration of the invention. Rather, the preceding description of the examples will provide those skilled in the art with an enabling description for implementing various examples. Various changes may be made in the function and arrangement of elements without departing from the spirit and scope of the present disclosure. Modifications are possible in the described examples, and other examples are possible, within the scope of the claims.

What is claimed is:

1. An apparatus comprising:
a power converter including:
a coupled inductor including a primary side terminal and a secondary side terminal;
a primary switch coupled to the primary side terminal; and
a rectifier switch coupled to the secondary side terminal;
a primary side controller coupled to the primary switch; and
a secondary side controller coupled to the rectifier switch,
wherein the primary side controller is configured to transmit a control signal to the secondary side controller via a wireless channel, the control signal indicating an operation mode of a plurality of operation modes of the power converter.

2. The apparatus of claim 1, wherein:
the power converter is a flyback converter; and
the plurality of operation modes includes a continuous conduction mode, a quasi-resonant mode, discontinuous conduction modes having different switching time, or a combination thereof.

3. The apparatus of claim 1, wherein the control signal includes one or more pulses in each switch cycle, a number of pulses in the switch cycle indicating a corresponding operation mode of the power converter.

4. The apparatus of claim 1, wherein the wireless channel includes an optical communication channel, a magnetic communication channel, or an electromagnetic communication channel.

5. The apparatus of claim 1, wherein each of the primary switch and the rectifier switch includes a transistor.

6. The apparatus of claim 1, wherein at least one of the primary switch or the rectifier switch includes a high electron mobility transistor.

7. The apparatus of claim 1, wherein the primary side controller is configured to:
select the operation mode from the plurality of operation modes;
generate the control signal based on the operation mode;
transmit the control signal via the wireless channel;
detect that a voltage level at the primary side terminal reaches zero; and
responsive to the detection, provide a primary side switching signal to switch a state of the primary switch.

8. The apparatus of claim 1, wherein the secondary side controller is configured to:
receive the control signal via the wireless channel;
determine at least one of the operation mode or switching timing of the power converter based on the control signal; and
provide, based on at least one of the operation mode or the switch timing, a secondary side switching signal to switch a state of the rectifier switch.

9. The apparatus of claim 1, wherein, in a switch cycle of an operation mode of the plurality of operation modes:
the primary side controller is configured to:
transmit the control signal to indicate a continuous conduction mode;
turn on the primary switch after a predetermined delay has elapsed from transmission of the control signal; and
turn off the primary switch after a time period; and
the secondary side controller is configured to:
receive the control signal;
determine, based on the control signal, that the power converter operates in the continuous conduction mode;
turn off the rectifier switch after a predetermine duration from receiving the control signal; and
responsive to a voltage across the rectifier switch reaching zero, turn on the rectifier switch.

10. The apparatus of claim 1, wherein, in a switch cycle of an operation mode of the plurality of operation modes:
the primary side controller is configured to:
transmit the control signal to indicate a quasi-resonant mode;
responsive to a voltage at the primary side terminal reaching zero, turn on the primary switch; and
turn off the primary switch after a time period; and
the secondary side controller is configured to:
receive the control signal;
determine, based on the control signal, that the power converter operates in the quasi-resonant mode;
responsive to a voltage across the rectifier switch reaching zero, turn on the rectifier switch; and
responsive to a zero crossing of a current at the secondary side terminal, turn off the rectifier switch after a predetermined delay has elapsed from the zero crossing.

11. The apparatus of claim 1, wherein, in a switch cycle of an operation mode of the plurality of operation modes:
the primary side controller is configured to:
transmit the control signal to indicate a discontinuous conduction mode and timing for turning on the primary switch in the switch cycle;
responsive to a voltage at the primary side terminal reaching zero, turn on the primary switch; and
turn off the primary switch after a time period; and
the secondary side controller is configured to:
receive the control signal;
determine, based on the control signal, that the power converter operates in the discontinuous conduction mode;
determine, based on the control signal, a condition for turning on the rectifier switch for a second time in the switch cycle;
responsive to a voltage across the rectifier switch reaching zero for a first time in the switch cycle, turn on the rectifier switch for a first time;
responsive to a zero crossing of a current at the secondary side terminal, turn off the rectifier switch;
responsive to detecting the condition, turn on the rectifier switch for the second time in the switch cycle; and
turn off the rectifier switch after a predetermined delay has elapsed from turning on the rectifier switch for the second time.

12. The apparatus of claim 11, wherein the condition includes at least one of: a number of valleys of a voltage of the secondary side terminal have been detected, a number of peaks of the voltage of the secondary side terminal have been skipped, a number of zero crossings of a current of the secondary side terminal have been detected, or a predetermined delay has elapsed.

13. The apparatus of claim 1, wherein the secondary side controller is configured to:
in a first switch cycle:
turn off the rectifier switch after a first delay has elapsed from a detection of a zero crossing of a current at the secondary side terminal or a valley of a voltage at the secondary side terminal; and
determine a rate of change of a drain voltage of the rectifier switch after turning off the rectifier switch; and
in a subsequent switch cycle, based on a comparison of the rate of change with a threshold value:
responsive to the rate of change being greater than the threshold value, turn off the rectifier switch after a second delay has elapsed from a detection of a zero crossing of the current at the secondary side terminal or a valley of voltage at the secondary side terminal, the second delay being longer than the first delay; or
in responsive to the rate of change being equal to or lower than the threshold value, turn off the rectifier switch after the first delay has elapsed from the detection of the zero crossing of the current at the secondary side terminal or the valley of the voltage at the secondary side terminal.

14. A apparatus for controlling a power converter, the apparatus comprising:
a controller configured to:
generate a switch control signal for controlling a switch of the power converter; and
generate a mode control signal that indicates a target operation mode selected from a plurality of operation modes of the power converter;
a first output terminal configured to output the switch control signal to control the switch; and
a second output terminal configured to transmit the mode control signal via a wireless channel.

15. The apparatus of claim 14, wherein the mode control signal includes one or more pulses in each switch cycle, a number of pulses in the switch cycle indicating a corresponding operation mode of the plurality of operation modes.

16. The apparatus of claim 14, wherein the wireless channel includes an optical communication channel, a magnetic communication channel, or an electromagnetic communication channel.

17. The apparatus of claim 14, wherein the controller is configured to:
in a first operation mode of the plurality of operation modes, generate the switch control signal to turn on the switch when a delay period has elapsed after the mode control signal is transmitted; and
in one or more other operation modes of the plurality of operation modes, generate the switch control signal to turn on the switch in response to detecting a valley or a zero voltage level of a voltage at a terminal of the switch.

18. An apparatus for controlling a power converter, the apparatus comprising:
an input terminal configured to receive a mode control signal through a wireless channel, the mode control signal indicating a target operation mode selected from a plurality of operation modes of the power converter;
a controller configured to, based on the mode control signal:
determine the target operation mode; and
generate a switch control signal for controlling a switch of the power converter in the target operation mode; and
an output terminal configured to output the switch control signal to control the switch.

19. The apparatus of claim 18, wherein the mode control signal includes one or more pulses in each switch cycle, a number of pulses in the switch cycle indicating a corresponding operation mode of the plurality of operation modes.

20. The apparatus of claim 18, wherein the wireless channel includes an optical communication channel, a magnetic communication channel, or an electromagnetic communication channel.

21. The apparatus of claim 18, wherein the controller is further configured to:
determine, based on the mode control signal, a number of valleys of a voltage at a terminal of the switch to skip before turning on the switch for a second time in a switch cycle;
determine a voltage level or a rate of change of the voltage at the terminal of the switch;
detect a zero crossing of a current of the switch;
detect a valley of the voltage at the terminal of the switch; or
a combination thereof.

22. The apparatus of claim 18, wherein the controller is configured to, in a switch cycle of an operation mode of the plurality of operation modes:
determine, based on the mode control signal, that the target operation mode is a continuous conduction mode;
turn off the switch after a predetermined duration from receiving the mode control signal; and
responsive to a voltage across the switch reaching zero, turn on the switch.

23. The apparatus of claim 18, wherein the controller is configured to, in a switch cycle of an operation mode of the plurality of operation modes:
determine, based on the mode control signal, that the target operation mode is a quasi-resonant mode;
responsive to a voltage across the switch reaching zero, turn on the switch; and
responsive to a zero crossing of a current of the switch, turn off the switch after a predetermined delay from the zero crossing.

24. The apparatus of claim 18, wherein the controller is configured to, in a switch cycle of an operation mode of the plurality of operation modes:
determine, based on the mode control signal, that the target operation mode is a discontinuous conduction mode;
determine, based on the mode control signal, a number of valleys of a voltage at a terminal of the switch to skip before turning on the switch for a second time in the switch cycle;
responsive to a voltage across the switch reaching zero for a first time in the switch cycle, turn on the switch;
responsive to a zero crossing of a current of the switch, turn off the switch;
responsive to detecting the number of valleys of the voltage at the terminal of the switch, turn on the switch for the second time in the switch cycle; and
turn off the switch after a predetermined delay.

25. The apparatus of claim 18, wherein the controller is configured to:
in a first switch cycle:
turn off the switch when a first delay has elapsed after a detection of a zero crossing of a current of the switch or a valley of a voltage at a terminal of the switch; and
determine a rate of change of the voltage at the terminal of the switch after turning off the switch; and
in a subsequent switch cycle, based on a comparison of the rate of change with a threshold value:
in responsive to the rate of change being greater than the threshold value, turn off the switch when a second delay has elapsed after a detection of a zero crossing of the current of the switch or a valley of the voltage at the terminal of the switch, the second delay being longer than the first delay; or
in responsive to the rate of change being equal to or lower than the threshold value, turn off the switch when the first delay has elapsed after the detection of the zero crossing of the current of the switch or the valley of the voltage at the terminal of the switch.

26. A method comprising:
selecting, by a primary side controller of a power converter, an operation mode from a plurality of operation modes of the power converter;
generating, by the primary side controller, a mode control signal based on the operation mode;
transmitting, via a wireless channel, the mode control signal from the primary side controller to a secondary side controller of the power converter;
generating, by the primary side controller and based on the operation mode, a primary switch control signal to control a primary switch on a primary side of the power converter;
determining, by the secondary side controller, the operation mode based on the mode control signal; and
generating, by the secondary side controller and based on the operation mode, a rectifier switch control signal to control a rectifier switch on a secondary side of the power converter.

27. The method of claim 26, wherein the mode control signal includes one or more pulses in each switch cycle, a number of pulses in the switch cycle indicating a corresponding operation mode of the plurality of operation modes.

28. The method of claim 26, wherein the plurality of operation modes includes a continuous conduction mode, a quasi-resonant mode, discontinuous conduction modes with different switching time, or a combination thereof.

29. The method of claim 26, wherein:
the operation mode is a continuous conduction mode;
generating the primary switch control signal to control the primary switch includes generating the primary switch control signal to:
turn on the primary switch after a predetermined delay from transmitting the mode control signal; and
turn off the primary switch after a time period; and
generating the rectifier switch control signal to control the rectifier switch includes generating the rectifier switch control signal to:
turn off the rectifier switch after a predetermine duration from receiving the mode control signal; and
responsive to a voltage across the rectifier switch reaching zero, turn on the rectifier switch.

30. The method of claim 26, wherein:
the operation mode is a quasi-resonant mode;
generating the primary switch control signal to control the primary switch includes generating the primary switch control signal to:
responsive to a voltage at a terminal of the primary switch reaching zero, turn on the primary switch; and
turn off the primary switch after a time period; and
generating the rectifier switch control signal to control the rectifier switch includes generating the rectifier switch control signal to:
responsive to a voltage across the rectifier switch reaching zero, turn on the rectifier switch; and
responsive to a zero crossing of a current of the rectifier switch, turn off the rectifier switch after a predetermined delay from the zero crossing.

31. The method of claim 26, wherein:
the operation mode is a discontinuous conduction mode;
generating the primary switch control signal to control the primary switch includes generating the primary switch control signal to:
responsive to a voltage at a terminal of the primary switch reaching zero, turn on the primary switch; and
turn off the primary switch after a time period;
determining the operation mode based on the mode control signal includes determining, based on the mode control signal, a number of valleys of a voltage at a terminal of the rectifier switch to skip before turning on the rectifier switch for a second time in a switch cycle; and
generating the rectifier switch control signal to control the rectifier switch includes generating the rectifier switch control signal to:
responsive to a voltage across the rectifier switch reaching zero, turn on the rectifier switch for a first time in the switch cycle;
responsive to a zero crossing of a current of the rectifier switch, turn off the rectifier switch;
responsive to detecting the number of valleys of the voltage at the terminal of the rectifier switch, turn on the rectifier switch for the second time in the switch cycle; and
turn off the rectifier switch after a predetermined delay.

32. The method of claim 26, further comprising:
in a first switch cycle:
turning off the rectifier switch when a first delay has elapsed from a detection of a zero crossing of a current of the rectifier switch or a valley of a voltage at a terminal of the rectifier switch; and
determining a rate of change of the voltage at the terminal of the rectifier switch after turning off the rectifier switch; and
in a subsequent switch cycle, based on a comparison of the rate of change with a threshold value:
in responsive to the rate of change being greater than the threshold value, turning off the rectifier switch when a second delay has elapsed from a detection of a zero crossing of the current of the rectifier switch or a valley of the voltage at the terminal of the rectifier switch, the second delay being longer than the first delay; or
in responsive to the rate of change being equal to or lower than the threshold value, turning off the rectifier switch when the first delay has elapsed from the detection of the zero crossing of the current of the rectifier switch or the valley of the voltage at the terminal of the rectifier switch.
